(19) United States
(12) Patent Application Publication
(10) Pub. No.: US 2012/0257540 A1
(43) Pub. Date: Oct. 11, 2012

(54) METHOD OF MANAGING A SYSTEM, AND COMPUTER PROGRAM PRODUCT

(75) Inventor: Goki ICHIKAWA, Nagoya-shi (JP)

(73) Assignee: BUFFALO INC., Nagoya-shi (JP)

(21) Appl. No.: 13/441,460

(22) Filed: Apr. 6, 2012

(30) Foreign Application Priority Data
Apr. 8, 2011 (JP) 2011-85866

(51) Int. Cl. H04L 12/28

(52) U.S. Cl. 370/254

(57) ABSTRACT

A method of managing a system, and associated computer program product, wherein the system includes a gateway device, a first device connected with the gateway device and a second device that is connected with the first device and has a greater number of devices intervening before the gateway device than the first device is provided. The method includes generating and displaying a connection configuration map including a symbol of the gateway device, a symbol of the first device and a symbol of the second device on a display unit of a management device. In the connection configuration map, the symbols of the gateway device, the first device and the second device are connected corresponding to actual connections, the symbol of the first device is located at a position having a shorter distance in a preset first direction from the symbol of the gateway device than the symbol of the second device, and connection interfaces of the gateway device, the first device and the second device are shown in an identifiable manner.

### CROSS-REFERENCE TO RELATED APPLICATION

This application claims priority under 35 U.S.C. §119 to Japanese Patent Application No. 2011-85866 filed on Apr. 8,2011, which is hereby incorporated by reference in its entirety and for all purposes.

### BACKGROUND

1. Technical Field

This disclosure relates to managing a system including a plurality of devices connected by various interfaces.

2. Related Art

With recent advancement of various interfaces for connection between devices, various devices are connected in the home or small business. For example, a personal computer and a router are connected by wireless connection; a TV tuner and a router are connected by a USB (Universal Serial Bus) cable or an HDMI (High-Definition Multimedia Interface) cable; and a printer and an NAS (Network Attached Storage) are connected by a USB cable and the NAS and a router are further connected by a LAN (Local Area Network) cable.

A management system is introduced for a network system including connections of a number of devices, in order to understand the connection configuration of the respective devices and gather information required for locating a failure (e.g., error log). For example, an SNMP (Simple Network Management Protocol) management system has been proposed as the management device (apparatus) for managing a network system where devices are connected by a LAN.

The SNMP management system is generally designed for a large-scaled network system and requires the high initial cost and advanced expertise for use, thus being not adequate for managing various devices, for example, in the home.

The SNMP management system is designed for devices connected by network interfaces, for example, router and server, as the management object and cannot manage devices connected by bus interfaces (for example, TV tuner and TV receiver interconnected by HDMI). Especially in the home or small business, an individual member (family member or employee) is likely to connect a device connected by a bus interface to another device without the permission of the other members, which increases in number of devices that are not manageable by the management system. Introducing a dedicated management system for each connection interface type disadvantageously increases the initial cost of the whole management system. Additionally, the user is required to operate different operation terminals of the respective management systems, in order to understand the connection configuration of all the devices. Understanding the connection configuration takes time and labor, and the advanced expertise is required for the respective management systems.

### SUMMARY

Consequently, there is a need to readily manage a plurality of devices connected by various interfaces.

In a method embodiment of managing a system, that includes a gateway device, a first device connected with the gateway device and a second device that is connected with the first device and has a greater number of devices intervening before the gateway device than the first device,

the method includes:

obtaining by an apparatus configuration information of the gateway device, configuration information of the first device and configuration information of the second device; and

generating and displaying on a display a connection configuration map based on the configuration information, wherein the connection configuration map includes
a symbol of the gateway device,
a symbol of the first device, and
a symbol of the second device that are displayed with display connections that correspond to actual connections between the gateway device, the first device and the second device, such that
the symbol of the first device is displayed on the display at a position having a shorter distance in a preset first direction from the symbol of the gateway device than the symbol of the second device, and
   connection interfaces of the gateway device, the first device and the second device are displayed in an identifiable manner.

According to a non-transitory computer readable storage medium embodiment, the medium includes instructions stored therein that when executed by a processing circuit performs a management control method for a system, the system includes

a gateway device, a first device connected with the gateway device and a second device, wherein the second device that is connected with the first device and has a greater number of devices intervening before the gateway device than the first device, wherein the management control method includes

obtaining by the processing circuit configuration information of the gateway device, configuration information of the first device and configuration information of the second device; and

generating and displaying on a display a connection configuration map based on the configuration information, wherein the connection configuration map includes
a symbol of the gateway device,
a symbol of the first device, and
a symbol of the second device that are displayed with display connections that correspond to actual connections between the gateway device, the first device and the second device, such that
the symbol of the first device is displayed on the display at a position having a shorter distance in a preset first direction from the symbol of the gateway device than the symbol of the second device, and
   connection interfaces of the gateway device, the first device and the second device are displayed in an identifiable manner.

### BRIEF DESCRIPTION OF THE DRAWINGS

FIG. 1 illustrates the general configuration of a system, to which a management device according to one embodiment of the invention is applied;

FIG. 2 is a block diagram illustrating the detailed structure of the router shown in FIG. 1;

FIG. 3 illustrates the general structure of the management PC shown in FIG. 1;

FIG. 4 illustrates the general structure of the device server shown in FIG. 1;

FIG. 5 is a sequence diagram showing a procedure of configuration information gathering process according to the first embodiment;

FIG. 6 illustrates an example of the lower-level device list created at step S215;

FIG. 7 schematically illustrates one example of configuration information gathering according to the first embodiment;

FIG. 8 illustrates an exemplary system configuration map displayed on the display as the result of the map generation process;

FIG. 9 is a flowchart showing the detailed procedure of step S120 shown in FIG. 5;

FIG. 10 illustrates the system configuration maps after the processing of step S910 and the processing of step S915 shown in FIG. 9;

FIG. 11 illustrates the system configuration maps after the processing of step S915 and the processing of step S920 shown in FIG. 9;

FIG. 12 illustrates the system configuration maps after the processing of step S920 and the processing of step S925 sown in FIG. 9;

FIG. 13 schematically illustrates the structure of a management PC according to a second embodiment;

FIG. 14 is a sequence diagram showing a procedure of configuration information gathering process according to the second embodiment;

FIG. 15 illustrates a system configuration map displayed on the display according to a third embodiment;

FIG. 16 illustrates a system configuration map displayed on the display according to a fourth embodiment;

FIG. 17 illustrates an exemplary system configuration map displayed on the display of the management PC according to one modification;

FIG. 18 schematically illustrates one example of the system connection configuration according to one modification;

FIG. 19 schematically illustrates another example of the system connection configuration according to another modification;

FIG. 20 schematically illustrates another example of the system connection configuration according to another modification;

FIG. 21 schematically illustrates another example of the system connection configuration according to another modification; and

FIG. 22 illustrates one example of system configuration map displayed on the display of the management PC according to one modification.

### DETAILED DESCRIPTION

### A. First Embodiment

### A1. General Configuration

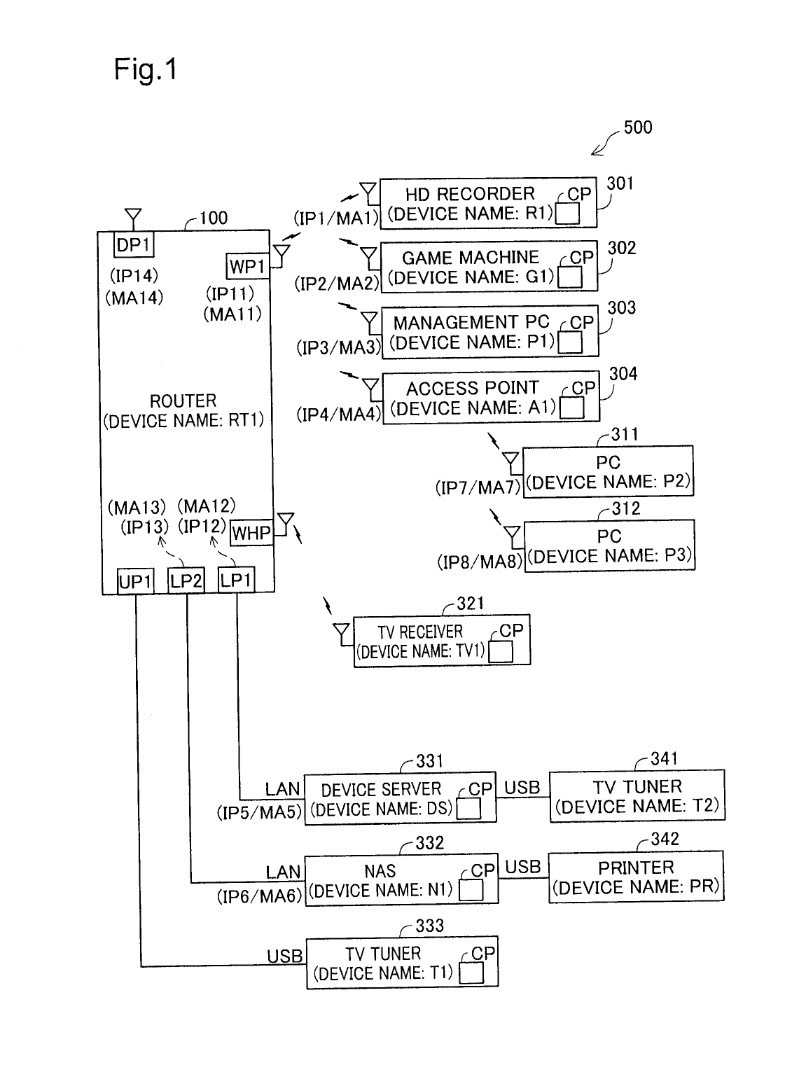

FIG. 1 illustrates the general configuration of a system, to which an apparatus according to one embodiment of the disclosure is applied. This system 500 includes a router 100 and a plurality of devices. More specifically, the system 500 includes the router 100, a hard disk recorder 301 a game machine 302, a management PC (personal computer) 303, a wireless LAN access point 304, two personal computers 311 and 312, a TV receiver 321, a device server 331, a TV tuner 341, an NAS (Network Attached Storage) 332, a printer 342 and a TV tuner 333. The system 500 serves to manage the connection configuration among the respective devices and the router 100, and the operating conditions of the respective devices, while allowing data transfer between the respective devices and data transfer between the respective devices and other devices (not shown) connected to the Internet.

In the system 500 with the router 100 centered, the devices are connected via either a network interface or a bus interface. In the description of the embodiment, the “network interface” means a connection interface conforming to, for example, the IEEE802.3 standard or the IEEE802.11 standard or a connection interface allowing mutual access to a plurality of devices, such as PLC (Power Line Communications), whilst the “bus interface” means a connection interface allowing access to one connected device, such as USB (Universal Serial Bus) or WHDI (Wireless Home Digital Interface). A higher-level device (e.g., device server 331) connected with a lower-level device (e.g., TV tuner 341) by the bus interface is allowed to access to the lower-level device, while any other device (e.g., hard disk recorder 301) is not allowed to directly access to this lower-level device.

The hard disk recorder 301, the game machine 302, the management PC 303, the wireless LAN access point 304 and the TV receiver 321 are directly connected with the router 100 by wireless connection. The device server 331, the NAS 332 and the TV tuner 333 are directly connected with the router 100 by wired connection. The two personal computers 311 and 312 are, however, indirectly connected with the router 100 via the wireless LAN access point 304. The TV tuner 341 and the printer 342 are also indirectly connected with the router 100 via the device server 331 and via the NAS 332, respectively. The respective devices are connected in this manner with the router 100 centered, since the router 100 serves to relay data (packets) between devices and enables connection of devices having different connection interfaces. The system 500 of such connection configuration is adoptable in the home or small business. The expression that two devices are “connected” includes both the meanings that the two devices are directly connected and that the two devices are indirectly connected. The expression that the two devices are directly connected means that the two devices are connected without any intermediate device, whilst the expression that the two devices are indirectly connected means that the two devices are connected via another device. For example, the expression of “directly connected with the router 100” means “connected with the router 100 without any other device”, whilst the expression of “indirectly connected with the router 100” means “connected with the router 100 via another device”. It should be further noted that when two devices are directly connected, the connection is facilitated by a bus interface or network interface, as defined above. In other words, while there may be no device disposed between the two devices that are directly connected, these devices are still connected via a bus interface, a cable or wire, or a wireless connection.

The router 100 includes a mobile communication control circuit DP1, a wireless LAN control circuit WP1, a WHDI control circuit WHP, two connection ports LP1 and LP2 and a USB control circuit UP1. The detailed structure of the router 100 including these circuits and ports will be described later. The router 100 is a wireless LAN (Local Area Network) router to relay packets (layer 2 frames and layer 3 packets) between the connected devices. Additionally, the router 100 has a hard disk drive (not shown), which is shared by another device to provide the NAS functions. The router 100 also serves as a DHCP (Dynamic Host Configuration Protocol) server that allocates an IP address to each device using TCP/IP (Transmission Control Protocol/ Internet Protocol) as the communication protocol, among the devices included in the system 500.

The hard disk recorder 301 includes a high-capacity hard disk (not shown) and a wireless LAN control circuit (not shown). The hard disk recorder 301 is wirelessly connected with the router 100 by the wireless LAN control circuit (not shown). The hard disk recorder 301 records data received from the router 100, while reading out specified data and sending the read-out data to the router 100.

The game machine 302 includes a wireless LAN control circuit (not shown) and is wirelessly connected with the router 100 by this wireless LAN control circuit. The game machine 302 transfers data on game contents (including voice and image data and data on operation details) to and from the router 100.

The management PC 303 is connected with the router 100 via a wireless LAN and manages the connection configuration of the respective devices in the system 500 and the operating conditions of the respective devices. The management PC 303 corresponds to the apparatus according to one embodiment of the disclosure. The details of the management PC 303 will be described later.

The wireless LAN access point 304 serves as a base station in the infrastructure mode, and wirelessly communicates with the two personal computers 311 and 312 serving as wireless LAN clients, while wirelessly communicating with the router 100 serving as the higher-level device.

Each of the two personal computers 311 and 312 includes a wireless LAN control circuit (not shown) and wirelessly communicates with the wireless LAN access point 304 to transfer data via the wireless LAN.

The TV receiver 321 has an embedded TV tuner (not shown) to receive TV airwaves (video signals and sound signals) and output video data and sound data. The TV receiver 321 also includes a WHDI control circuit (not shown) to establish WHDI-based wireless communication with the router 100. The connection of the TV receiver 321 with the router 100 via WHDI enables, for example, the images and sounds output from the TV receiver 321 to be sent to the hard disk recorder 301 via the router 100 and stored in the hard disk recorder 301.

The device server 331 includes a USB control circuit (not shown) and a wired LAN control circuit (not shown), and is connected with the TV tuner 341 by a USB cable and with the router 100 (connection port LP1) by a LAN cable. The device server 331 receives video data and sound data output from the TV tuner 341 according to a USB protocol and outputs the received video data and sound data in the form of wired LAN frames (e.g., Ethernet (registered trademark) frames) to the router 100. The device server 331, on the other hand, creates a USB frame from frames received from the router 100 and outputs the USB frame to the TV tuner 341. Using the device server 331 to connect the TV tuner 341 to a wired LAN enables, for example, the video data and sound data output from the TV tuner 341 to be sent to and recorded in the hard disk recorder 301 via the wired LAN or wireless LAN or to be sent to and reproduced by the TV receiver 321.

The TV tuner 341 receives TV airwaves and outputs video data and sound data. The TV tuner 341 includes a USB control circuit (not shown) to send the video data and sound data to the device server 331 by USB.

The NAS 332 includes a high-capacity hard disk (not shown), a wired LAN control circuit (not shown) and a USB control circuit (not shown) and is connected with the router 100 (connection port LP2) by a LAN cable and with the printer 342 by a USB cable. The NAS 332 records data received from the router 100 or the printer 342, and reads out recorded data and outputting the read-out data to the router 100 or the printer 342.

The printer 342 is, for example, an inkjet printer and serves to receive images stored in the NAS 332 via the USB cable and print the received images. The printer 342 has image processing functions, for example, sharpness control and skin color control and sends and stores the processed images to and in the NAS 332 via the USB cable.

The TV tuner 333 includes a USB control circuit (not shown) and outputs the received TV airwaves (video signals and sound signals) to the router 100 via the USB cable. Connecting the TV tuner 333 with the router 100 intends to achieve the same purposes as those by connecting the TV tuner 341 with the router 100 via the device server 331 described above. In one expected application, the TV tuner 341 may be placed, for example, in a child's room, while the TV tuner 333 may be placed, for example, in a living room.

In the system 500, an IP (Internet Protocol) address is allocated to each of the devices connected to either the wireless LAN or the wired LAN, in order to allow TCP/IP-based communication. More specifically, an IP address “IP11” is allocated to the wireless LAN control circuit WP1 of the router 100, an. IP address “IP12” to the connection port LP1 of the router 100, an IP address “IP13” to the connection port LP2 of the router 100, and an IP address “IP14” to the mobile communication control circuit DP1 of the router 100. IP addresses “IP1”, “IP2”, “IP3”, “IP4”, “IP5”, “IP6”, “IP7” and “IP8” are respectively allocated to the hard disk recorder 301, the game machine 302, the management PC 303, the wireless LAN access point 304, the device server 331, the NAS 332, the personal computer 311 and the personal computer 312. Although the respective IP addresses are represented by symbolic values for the convenience of explanation, a 32-bit address (IPv4) or a 128-bit address (IPv6) is actually allocated to each device. In the system 500, the router 100 (DHCP server) allocates an IP address to each device when the device enters the wireless LAN or the wired LAN.

A MAC (Media Access Control) address is allocated to each of the devices connected to either the wireless LAN or the wired LAN, in order to allow communication conforming to the IEEE802.3 standard, such as Ethernet (registered trademark). Specifically, a MAC address “MA11” is allocated to the wireless LAN control circuit WP1 of the router 100, a MAC address “MA12” to the connection port LP1 of the router 100, a MAC address “MA13” to the connection port LP2 of the router 100, and a MAC address “MA14” to the mobile communication control circuit DP1 of the router 100. MAC addresses “MA1”, “MA2”, “MA3”, “MA4”, “MA5”, “MA6”, “MA7” and “MA8” are respectively allocated to the hard disk recorder 301, the game machine 302, the management PC 303, the wireless LAN access point 304, the device server 331, the NAS 332, the personal computer 311 and the personal computer 312. Although the respective MAC addresses are represented by the symbolic values for the convenience of explanation, a 48-bit address is actually allocated to each device.

A device name is set in each of the devices included in the system 500. Specifically, a device name “RT1” is set to the router 100, a device name “R1” to the hard disk recorder 301, “G1” to the game machine 301, “P1” to the management PC 303, “A1” to the wireless LAN access point 304, “P2” to the personal computer 311, “P3” to the personal computer 312, “TV1” to the TV receiver 321, “DS” to the device server 331, “N1” to the NAS 332, “T1” to the TV tuner 333, “T2” to the TV tuner 341 and “PR” to the printer 342. The device names for the respective devices may be set, for example, before shipment and stored in nonvolatile memories (e.g., EEPROMs) of the respective devices.

In the system 500, some of the devices connected with the router 100 have a configuration information acquisition-relevant module CP. Specifically, the hard disk recorder 301, the game machine 302, the management PC 303, the wireless LAN access point 304, the TV receiver 321, the device server 331, the NAS 332 and the TV tuner 333 have the configuration information acquisition-relevant module CP. The configuration information acquisition-relevant module CP performs a configuration information gathering process described later. None of the two personal computers 311 and 312, the TV tuner 341 and the printer 342, however, has the configuration information acquisition-relevant module CP.

### A2. Structure of Router

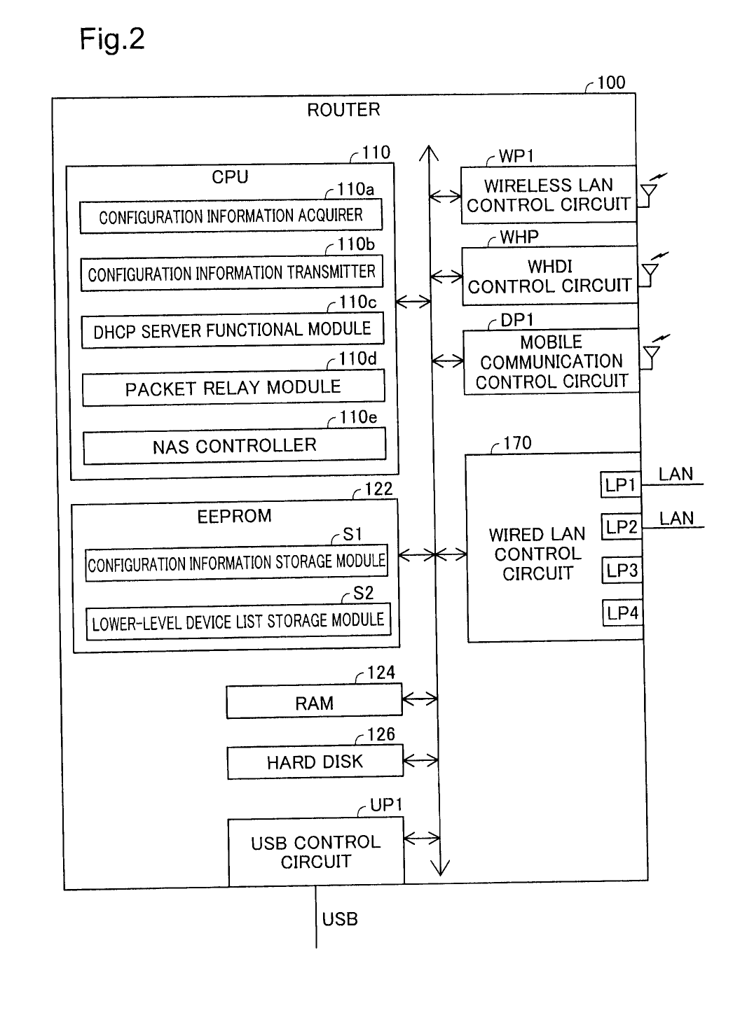

FIG. 2 is a block diagram illustrating the detailed structure of the router shown in FIG. 1. The router 100 includes a CPU (Central Processing Unit) 110, an EEPROM (Electrically Erasable and Programmable Read Only Memory) 122, a RAM (Random Access Memory) 124, a hard disk 126, the USB control circuit UP1, the wireless LAN control circuit WP1, the WHDI control circuit WHP, the mobile communication control circuit DP1, and a wired LAN control circuit 170, which are connected by an internal bus.

A preset application program is stored in the EEPROM 122, and the CPU 110 performs this application program under a specific operating system to serve as a configuration information acquirer 110a, a configuration information transmitter 110b, a DHCP server functional module 110c, a packet relay module 110d and an NAS controller 110e.

The configuration information acquirer 110a is a functional module to obtain the own configuration information and the configuration information of other devices. According to this embodiment, the “configuration information” includes information on the device type, the device name, the connection interface type with another device and the operating condition. The configuration information transmitter 110b sends the configuration information obtained by the configuration information acquirer 110a to the management PC 303. The DHCP server functional module 110c functions as a DHCP server to allocate an IP address and a subnet mask to each device and provide information, such as address of a gateway server. The packet relay module 110d relays an IP packet received via each of the interfaces included in the router 100, based on the IP address. The NAS controller 110e manages access control and storage areas when the router 100 serves as the NAS with using the hard disk 126 as a shared disk.

The EEPROM 122 includes a configuration information storage module S1 and a lower-level device list storage module S2. The configuration information storage module S1 stores the configuration information obtained from other devices, in addition to the own configuration information. The own configuration information includes, for example, the device name as the router, the remaining capacity of the embedded hard disk 126, the received signal strength from each device connected by the wireless LAN, the type of each interface included in the router 100 (wireless LAN, wired LAN, WHDI or USB), the operating condition of each circuit (e.g., during normal operation or during wireless connection), and an association list of the wireless LAN. These information may be obtained by an initialization sequence (for example, USB enumeration) defined in each interface, for example, at the start-up of the router 100 or on connection of a USB device to the router 100. These information may also be obtained by the configuration information gathering process described later. The lower-level device list storage module S2 stores a lower-level device list described later.

The wireless LAN control circuit WP1 includes a modulator, an amplifier and an antenna and serves as a wireless LAN access point conforming to, for example, the IEEE802.11b/g standard to wirelessly communicate with the hard disk recorder 301, the game machine 302 and the management PC 303 as wireless LAN clients. The wireless LAN control circuit WP1 also wirelessly communicates with the wireless LAN access point 304 serving as another wireless LAN access point.

The WHDI control circuit WHP includes a modulator, an amplifier and an antenna and performs WHDI-based wireless communication (near field wireless communication in a frequency range of 5 GHz). The mobile communication control circuit DP1 includes a modulator, an amplifier and an antenna and serves as a mobile communications station conforming to, for example, the 3G/HSPA protocol to wireless communicate with an access point of a mobile communications network.

The wireless LAN control circuit 170 has four connection ports LP1 to LP4 and is involved in reception and transmission of frames in conformity with the IEEE802.3 standard, creation of an IP packet from received frames (layer 2 frames), and division of an IP packet including data to be output into frames (layer 2 frames).

### A3. Structure of Management PC

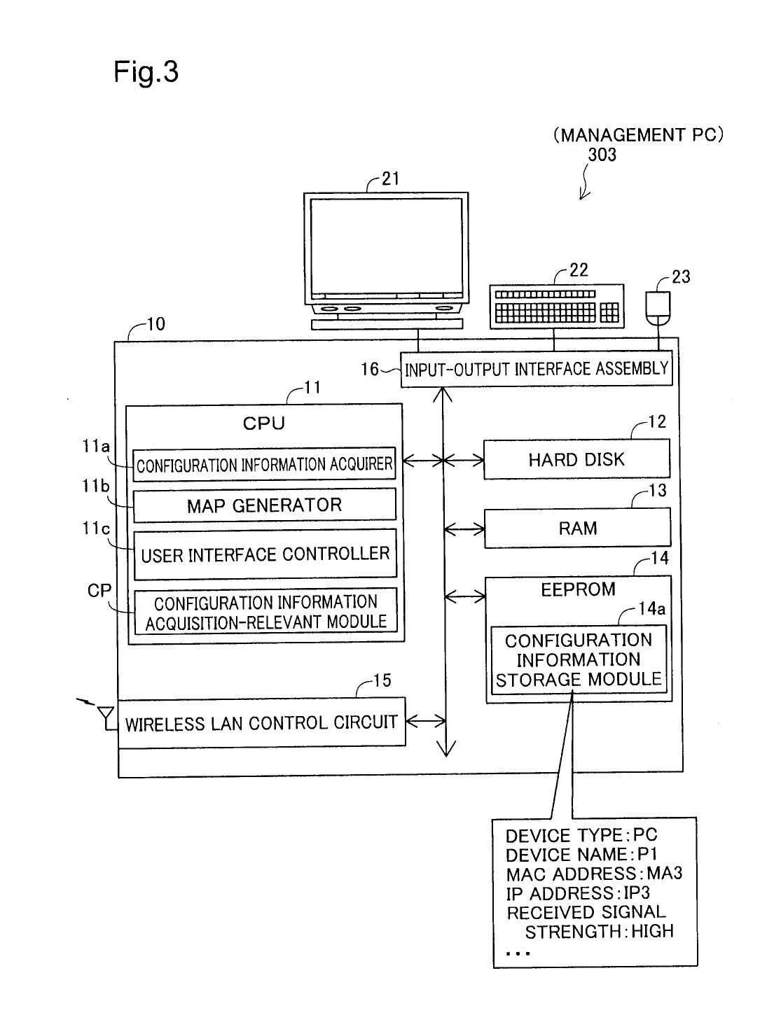

FIG. 3 illustrates the general structure of the management PC shown in FIG. 1. The management PC 303 includes a computer body 10, a display 21, a keyboard 22 and a mouse 23. The computer body 10 includes a CPU 11, a hard disk 12, a RAM 13, an EEPROM 14, a wireless LAN control circuit 15 and an input-output interface assembly 16.

An application program for management of the system 500 is stored in the hard disk 12, and the CPU 11 performs this application program under a specific operating system to serve as a configuration information acquirer 11a, a map generator 11b, a user interface controller 11c and a configuration information acquisition-relevant module CP.

The configuration information acquirer 11a obtains the configuration information of the respective devices included in the system 500, as well as the own configuration information. The map generator 11b generates a system configuration map for centralized management of the configuration information of the respective devices included in the system 500 and the operating conditions of the respective devices. The user interface controller 11c causes the configuration map generated by the map generator 11b to be displayed in a user-identifiable display format on the display 21. The user interface controller 11c also receives and accepts the user's various operations of the keyboard 22 and the mouse 23. The configuration information acquisition-relevant module CP obtains the configuration information of the management PC 303 and notifies the router 100 of the obtained configuration information. This configuration information acquisition-relevant module CP has the same functions as those of the configuration information acquisition-relevant modules CP provided in the devices shown in FIG. 1 (e.g., hard disk recorder 301 and game machine 302).

The wireless LAN control circuit 15 includes a modulator, an amplifier and an antenna and serves as a wireless LAN client conforming to, for example, the IEEE802.11b/g standard.

The EEPROM 14 has a configuration information storage module 14a. The own configuration information of the management PC 303 and the configuration information of other devices are stored in this configuration information storage module 14a. In the illustrated example of FIG. 3, the device type “PC”, the device name “P1”, the MAC address “MA3”, the IP address “IP3” and the received signal strength “high” are stored in the configuration information storage module 14a as part of the own configuration information of the management PC 303.

The input-output interface assembly 16 includes a group of interfaces used to connect the display 21, the keyboard 22 and the mouse 23 with the computer body 10.

### A4. Structure of Other Device

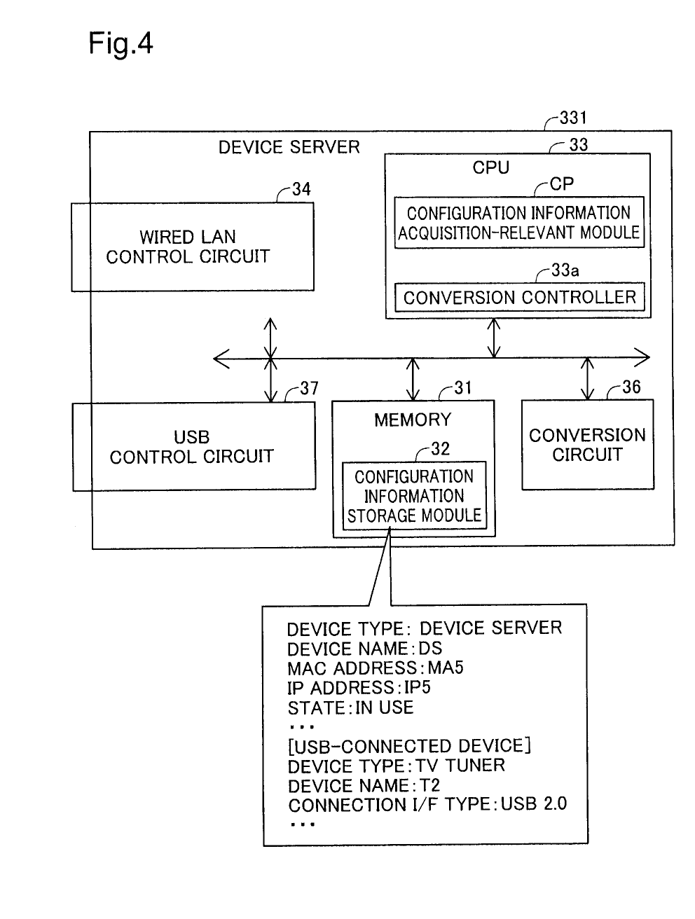

FIG. 4 illustrates the general structure of the device server shown in FIG. 1. The device server 331 includes a memory 31, a CPU 33, a wired LAN control circuit 34, a conversion circuit 36 and a USB control circuit 37.

The memory 31 consists of, for example, a RAM and an EEPROM (not shown) and has a configuration information storage module 32. The configuration information storage module 32 stores the own configuration information of the device server 331 and the configuration information of each device connected with the device server 331. In the illustrated example of FIG. 4, the device type “device server”, the device name “DS”, the MAC address “MA5”, the IP address “IP5” and the operating condition “in use” are stored in the configuration information storage module 32 as part of the own configuration information of the device server 331. The configuration information on the TV tuner 341 connected with the device server 331 (i.e., device type “TV tuner”, device name “T2”, and connection interface type “USB2.0”) is also stored in the configuration information storage module 32.

The CPU 33 performs a program stored in the memory 31 to serve as a configuration information acquisition-relevant module CP and a conversion controller 33a. The configuration information acquisition-relevant module CP has the similar functions to those of the configuration information acquisition-relevant module CP of the management PC 303 shown in FIG. 3. The conversion controller 33a controls the operations of the conversion circuit 36.

Like the wired LAN control circuit 170 shown in FIG. 2, the wired LAN control circuit 34 is involved in reception and transmission of frames conforming to the IEEE802.3 standard. The conversion circuit 36 converts a frame in conformity with the IEEE802.3 standard into a USB2.0 format, or vice versa. The USB control circuit 37 is involved in reception and transmission of data according to the USB2.0 protocol.

The device server 331 shown in FIG. 4 has the configuration information acquisition-relevant module CP and the configuration information storage module 32 unlike the conventional device server, but otherwise has the same structure as that of the conventional device server. Similarly, each of the other devices with the configuration information acquisition-relevant module CP but the management PC 303 (i.e., hard disk recorder 301, game machine 302, wireless LAN access point 304, TV receiver 321, NAS 332 and TV tuner 333) has the configuration information acquisition-relevant module CP and a corresponding configuration information storage module unlike the conventional corresponding device, but otherwise has the same structure as that of the conventional corresponding device.

In the system 500 of the above configuration, the configuration information gathering process described below enables the user to easily manage the connection configurations and the operating conditions of the respective devices included in the system 500. The router 100 corresponds to the gateway device in the claims. The device name of each device corresponds to the device specific information in the claims, the IP address or MAC address of each device to the address information in the claims, the configuration information acquirer 11a of the management PC 303 to the configuration information acquirer in the claims, the display 21 to the display unit in the claims, the map generator 11b and the user interface controller 11c to the map display controller in the claims, and the wireless LAN control circuit 15 and the CPU 11 to the communication controller in the claims.

### A5. Configuration Information Gathering Process

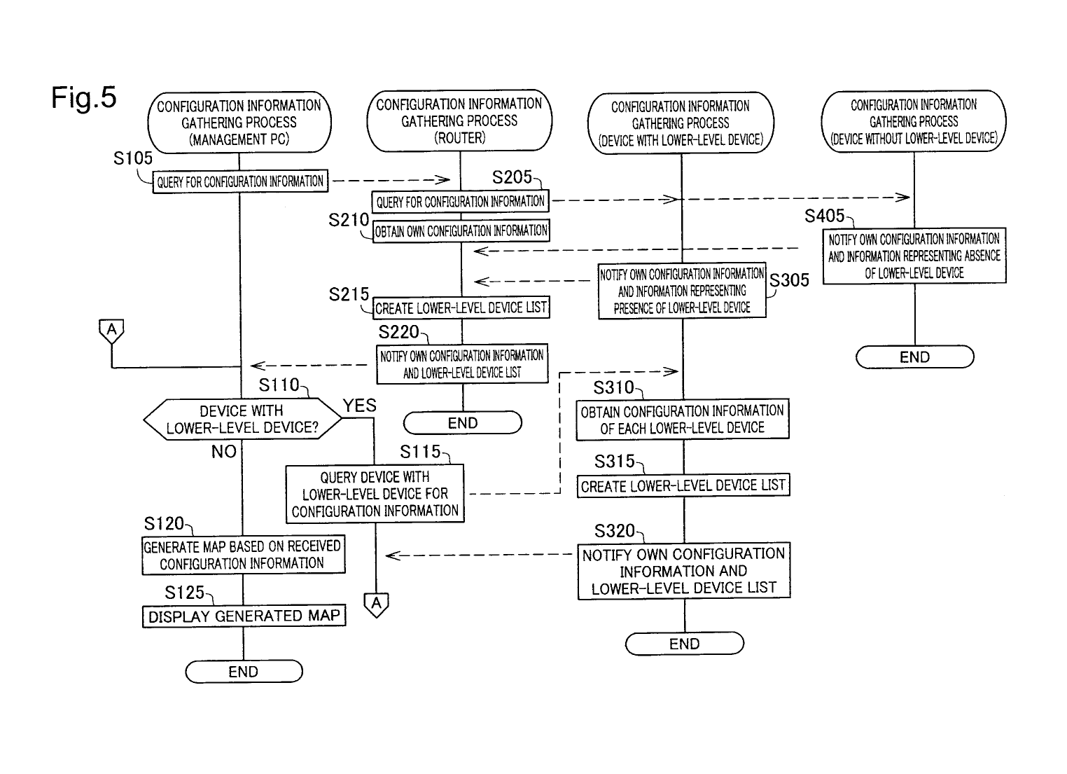

FIG. 5 is a sequence diagram showing a procedure of configuration information gathering process according to the first embodiment. The leftmost flow shows the processing flow of the management PC 303. The second left flow, the third left flow and the rightmost flow respectively show the processing flow of the router 100, the processing flow of a device with any lower-level device but the router 100 and the processing flow of a device without any lower-level device. The “lower-level device” of a target device herein means a device connected to the target device, such as to be more distant from the router 100 (i.e., a greater number of devices intervening before the router 100) than the target device. For example, the devices directly connected with the router 100 by wired connection or by wireless connection (i.e., hard disk recorder 301, game machine 302, management PC 303, wireless LAN access point 304, TV receiver 321, device server 331, NAS 332 and TV tuner 333) are the lower-level devices of the router 100. The two personal computers 311 and 312 are the lower-level devices of the wireless LAN access point 304. In other words, the wireless LAN access point 304 is the device with any lower-level device (two personal computers 311 and 312). Similarly, the device server 331 is the device with arbitrary lower-level device (TV tuner 341), and the NAS 332 is the device with arbitrary lower-level device (printer 342). The hard disk recorder 301, the game machine 302, the management PC 303, the TV receiver 321 and the TV tuner 333 are, on the other hand, the devices without arbitrary lower-level device.

In the system 500, after the start-up of the management PC 303, the configuration information gathering process is performed at preset intervals. The configuration information acquirer 11a of the management PC 303 shown in FIG. 3 first queries the router 100 for configuration information (step S105). In an application that the management PC 303 and the router 100 are devices conforming to DLNA (Digital Living Network Alliance) and that the management PC 303 and the router 100 respectively serves as a DMP (Digital Media Player) and as a DMS (Digital Media Server), the management PC 303 may adopt, for example, the GET method to require device description of the router 100 to implement the query for configuration information. The address of the router 100 required for the query to the router 100 may be obtained, for example, from the settings sin the management PC 303.

In response to the query from the management PC 303, the configuration information acquirer 110a of the router 100 shown in FIG. 2 queries each lower-level device for configuration information (step S205). This query may be performed in the same manner as the query at step S105 described above.

In response to the query for configuration information from the router 100, the device with arbitrary lower-level device gathers the own configuration information and replies back this own configuration information and information representing the presence of lower-level device to the router 100 (step S305). For example, the configuration information acquisition-relevant module CP of the device server 331 shown in FIG. 4 reads out the own configuration information (i.e., device type, device name, MAC address, IP address and operating condition) stored in the configuration information storage module 32 and sends this own configuration information and information representing the presence of lower-level device to the router 100. The configuration information acquisition-relevant module CP may query the conversion controller 33a for any device connected to the USB control circuit, in order to check whether the device server 331 has any lower-level device (i.e., whether the device server 331 has any USB-connected device).

As shown in FIG. 5, in response to the query for configuration information from the router 100, the device without any lower-level device, on the other hand, gathers the own configuration information and replies back this own configuration information and information representing the absence of lower-level device to the router 100 (step S405). For example, the configuration information acquisition-relevant module CP of the management PC 303 reads out the own configuration information (i.e., device type, device name, MAC address, IP address and received signal strength) stored in the configuration information storage module 14a and sends this own configuration information to the router 100.

After querying each lower-level device for configuration information (step S205), the configuration information acquirer 110a of the router 100 obtains the own configuration information and stores the own configuration information into the configuration information storage module S1 (step S210). For example, the configuration information acquirer 110a may query the mobile communication control circuit DP1 for operating condition, obtain the operating condition of “during communication” and store the operating condition into the configuration information storage module S1. In another example, the configuration information acquirer 110a may query the NAS controller 110e for used capacity of the hard disk 126, obtain the operating condition of “80% in use” and store the operating condition into the configuration information storage module S1.

The configuration information acquirer 110a of the router 100 stores the configuration information received from each lower-level device into the configuration information storage module S1 shown in FIG. 2, while creating a lower-level device list based on the received configuration information and storing the created lower-level device list into the lower-level device list storage module S2 (step S215).

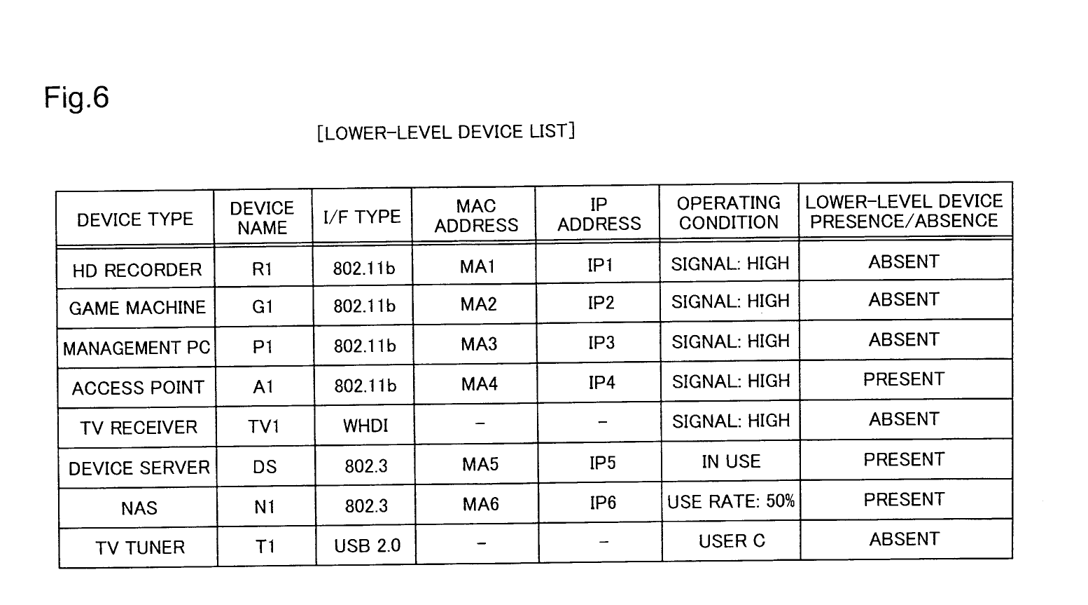

FIG. 6 illustrates an example of the lower-level device list created at step S215. As shown in FIG. 6, the lower-level device list records the device type, the device name, the interface (I/F) type, the MAC address, the IP address, the operating condition, and the presence or absence of lower-level device, with respect each of the lower-level devices of the router 100. For example, the device type “hard disk recorder”, the device name “R1”, the I/F type “802.11b”, the MAC address “MA1”, the IP address “IP1”, the operating condition “signal: high” and the lower-level device presence/absence “absent” are recorded with respect to the hard disk recorder 301.

The configuration information transmitter 110b of the router 100 sends the own configuration information obtained at step S210 and the lower-level device list created at step S215 to the management PC 303 (step S220).

When receiving the lower-level device list, the configuration information acquirer 11a of the management PC 303 stores the received lower-level device list into the configuration information storage module 14a and checks for the presence or absence of any lower-level device with respect to each of the devices enumerated in the lower-level device list (step S110) and queries each device with any lower-level device for configuration information (step S115). The devices with any lower-level device other than the router 100 in the system 500 include the wireless LAN access point 304, the device server 331 and the NAS 332. These devices have the setting of “present” in the lower-level device presence/absence field in the lower-level device list as shown in FIG. 6. The presence or absence of any lower-level device can thus be checked, based on the setting in this field. The addresses of the device with any lower-level device (MAC address and IP address) may be obtained from the lower-level device list.

As shown in FIG. 5, when receiving the query for configuration information from the management PC 303, the configuration information acquisition-relevant module CP of the device with any lower-level device obtains the configuration information of each lower-level device (step S310). For example, the configuration information of each lower-level device may be obtained by sending a configuration information notification request (e.g., http command) to each lower-level device and receiving a reply from the lower-level device. More specifically, the configuration information acquisition-relevant module CP of the wireless LAN access point 304 may send a configuration information notification request to the two personal computers 311 and 312. In another example, the configuration information of each lower-level device may be obtained by reading out the configuration information, which has been obtained in the initialization sequence on connection of the lower-level device and stored in the memory of the lower-level device. More specifically, the configuration information acquisition-relevant module CP of the device server 331 may read out the configuration information (device type “TV tuner”, device name “T2”, and connection interface type “USB2.0”) obtained in the initialization sequence on USB connection of the TV tuner 341 and stored in the configuration information storage module 32.

After obtaining the configuration information of each lower-level device, the configuration information acquisition-relevant module CP of the device with any lower-level device creates a lower-level device list (step S315) and sends the created lower-level device list and the own configuration information to the management PC 303 (step S320). The lower-level device list created at step S315 has the same structure as that of the lower-level device list shown in FIG. 6.

When receiving the lower-level device list from the device with any lower-level device after step S115, the configuration information acquirer 11a of the management PC 303 performs step S110 described above again (i.e., checking for the presence or absence of any lower-level device with respect to each of the devices enumerated in the newly received lower-level device list).

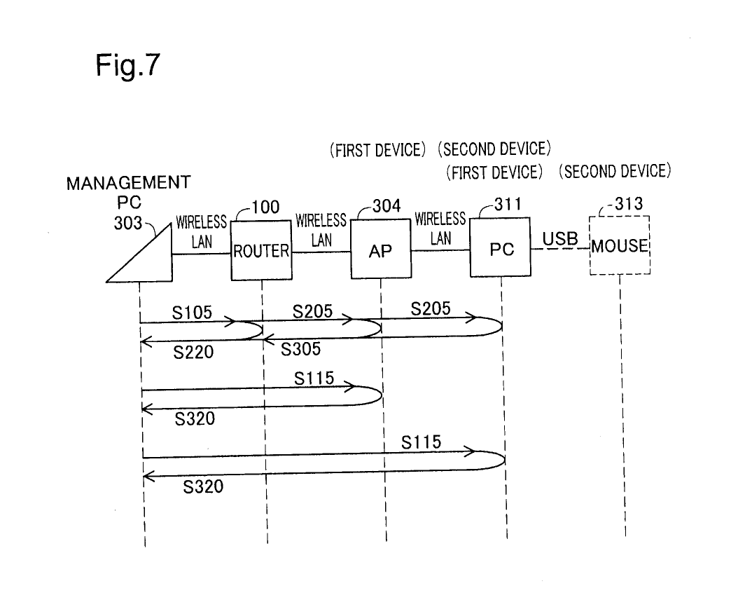

FIG. 7 schematically illustrates one example of configuration information gathering according to the first embodiment. FIG. 7 schematically shows the processing flow when the management PC 303 gathers the configuration information from the router 100, the wireless LAN access point 304 and the personal computer 311.

The management PC 303 obtains the configuration information and the lower-level device list of the router 100 from the router 100 at step S105 and S220. In response to the query at step S105, the query for configuration information (S205) and the reply (S305) is performed between the router 100 and the wireless LAN access point 304 or the personal computer 311. The lower-level device list obtained from the router 100 includes the MAC address and the IP address of each of the devices with any lower-level device as shown in FIG. 6. The management PC 303 accordingly obtains the configuration information and the lower-level device list of the wireless LAN access point 304 from the wireless LAN access point 304 at steps S115 and S320. Similarly, the management PC 303 refers to the lower-level device list obtained from the wireless LAN access point 304 and obtains the configuration information and the lower-level device list of the personal computer 311 from the personal computer 311 at steps S115 and S320. As shown by the broken line in FIG. 7, when the mouse 313 is connected with the personal computer 311 by USB interface, the personal computer 311 creates and sends a lower-level device list including the mouse 313 to the router 100.

The procedure of this embodiment repeats the processing of steps S110 and S115 in this manner until any of the lower-level devices has no further lower-level device. The personal computer 311 is the lower-level device of the wireless LAN access point 304 and is also the device with the mouse 313 as its lower-level device. In the combination (pair) of the wireless LAN access point 304 and the personal computer 311, the wireless LAN access point 304 corresponds to the first device (previous first device) in the claims of the disclosure, while the personal computer 311 corresponds to the second device (previous second device) in the claims. In the pair of the personal computer 311 and the mouse 313, the personal computer 311 corresponds to the first device (current first device) in the claims, while the mouse 313 corresponds to the second device (current second device) in the claims. Sequentially sliding the pairing of two devices to change a certain device from the previous second device to the current first device should be regarded in the scope of the claims of the disclosure. The processing of steps S105 and S220 or the processing of steps S115 and S320 corresponds to the first processing in the claims. The combination of the process of querying at step S115 and the process of obtaining the configuration information at step S320 with respect to each of the lower-level devices enumerated in the lower-level device list obtained by the processing of step S115 and S320 corresponds to the second processing in the claims.

The connection interface in the pair of the wireless LAN access point 304 and the personal computer 311 is the network interface (wireless LAN), whilst the connection interface in the pair of the personal computer 311 and the mouse 313 is the bus interface (USB). According to this embodiment, irrespective of whether the connection interface between the first device and the second device is the network interface or the bus interface, the first device obtains the configuration information of the second device and notifies the management PC 303 of the obtained configuration information.

Referring back to FIG. 5, when the lower-level device list includes no device with any lower-level device (step S110: No), the map generator 11b of the management PC 303 performs a map generation process to generate a system configuration map, based on the received configuration information and lower-level device list of the router 100 (step S120). The user interface controller 11c of the management PC 303 displays the system configuration map generated at step S120 on the display 21 (step S125).

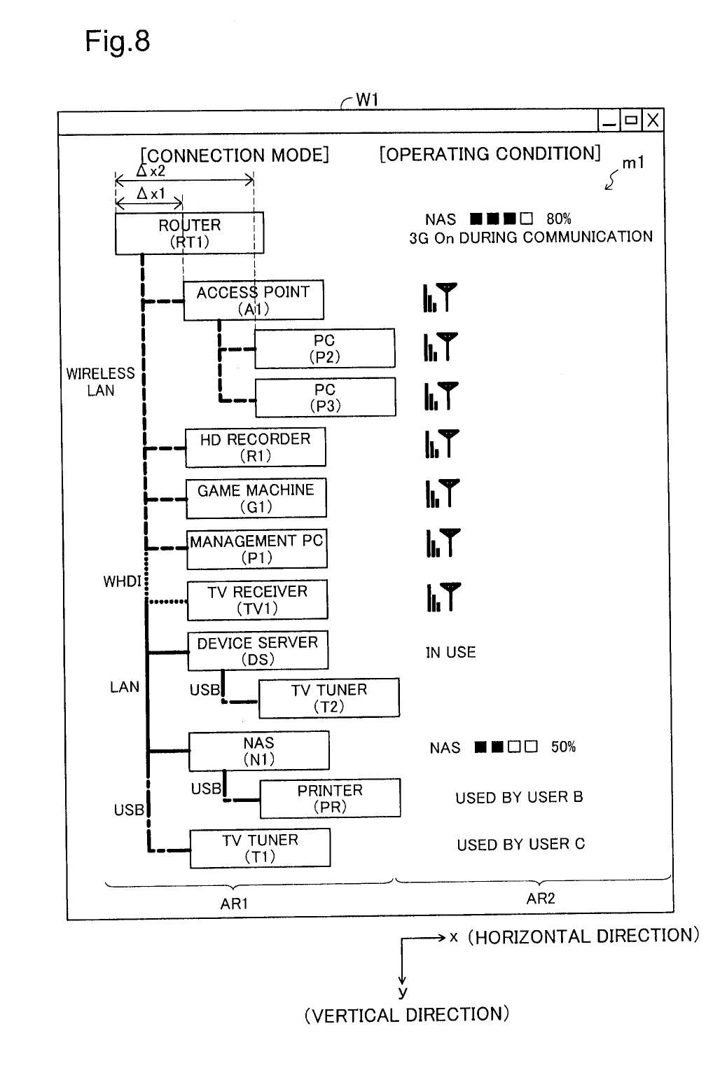

FIG. 8 illustrates an exemplary system configuration map displayed on the display as the result of the map generation process. A system configuration map m1 shown in FIG. 8 is generated at step S120 and is displayed in a window W1 on the display 21. The longitudinal direction (y direction) of the window W1 is parallel to the vertical direction, and the lateral direction (x direction) of the window W1 is parallel to the horizontal direction. As shown in FIG. 8, the length of the window W1 in the longitudinal direction is longer than the width of the window W1 in the lateral direction. The window W1 corresponds to the display area in the claims of the disclosure, and the longitudinal direction and the lateral direction of the window W1 respectively correspond to the longitudinal direction and the lateral direction in the claims.

The system configuration map m1 includes a connection mode display area AR1 and an operating condition display area AR2. Symbols representing the respective devices included in the system 500, the device types and the device names of the respective devices, and the connection interface types between the respective devices are displayed in the connection mode display area AR1. The operating conditions of the respective devices included in the system 500 are displayed in the operating condition display area AR2.

As shown in FIG. 8, the symbols representing the respective devices included in the system 500 are arrayed in the y direction (vertical direction) from the router 100 as the starting point in the connection mode display area AR1. This y direction (vertical direction) corresponds to the preset second direction in the claims. The symbols of the respective devices are rectangles of the same size, and the device type and the device name of each device are shown in the corresponding symbol.

The symbols of the respective devices are disposed in the connection mode display area AR1 to clarify the hierarchical structure of the respective devices. Specifically, the symbol of the router 100 is located at the uppermost left position. The symbol of each device directly connected with the router 100 by wireless connection or by wired connection is located at offset Δx1 right in the x direction (horizontal direction) from the symbol of the router 100. The symbol of each device not directly connected with the router 100 is, on the other hand, located at offset Δx2 right in the x direction (horizontal direction) from the symbol of the router 100, wherein the offset Δx2 is greater than the offset Δx1. The respective symbols are accordingly displayed, such that the router 100 is located at the highest hierarchical level, the devices directly connected with the router 100 are located at the second hierarchical level, and the devices not directly connected with the router 100 are located at the third hierarchical level, as shown in FIG. 8. In other words, the symbol (for example, symbol A1 of the device (first device) directly connected with the router 100 is located at the position having a shorter distance in the x direction (horizontal direction) from the symbol of the router 100 than the symbol (for example, symbol P2) of the device (second device) that is connected with the first device and has a greater number of devices intervening before the router 100. This x direction corresponds to the preset first direction in the claims. Such hierarchical arrangement of the symbols representing the respective devices enables the user to readily understand the connections between the respective devices. According to this embodiment, the symbol of a second device (for example, symbol P2) connected with a first device is arranged below the symbol of the first device (for example, symbol A1) in the y direction (vertical direction), so that the symbol of the first device is located at the position closer to the symbol of the router 100 than the symbol of the second device. This enables the user to sensuously and easily understand the connections between the respective devices.

The symbols of the respective devices are grouped by the connection interface type with the router 100. More specifically, the symbols of the devices having the wireless LAN as the connection interface type are grouped first to be arranged at the closest position to the symbol of the router 100 in the y direction. Similarly, the symbols of the devices having the WHDI as the connection interface type, the symbols of the devices having the wired LAN as the connection interface type, and the symbols of the devices having the USB as the connection interface type are sequentially grouped to be arranged at the second closest position, at the third closest position, and at the fourth closest position, to the symbol of the router 100. Such grouping display of the symbols of the devices by the connection interface type with the router 100 enables the user to readily understand how many devices are connected for each type of the connection interface. Additionally, the symbols of the devices having the wireless connection interface with the router 100 are located at the position closer to the symbol of the router 100 in the y direction than the symbols of the devices having the wired connection interface with the router 100, because of the following reason. With respect to the devices having the wired connection interface with the router 100, it is relatively easy to identify which device is connected with the router 100 by tracking the cables used for connection. With respect to the devices having the wireless connection interface with the router 100, on the other hand, it is not easy to identify whether each device is connected with or not connected with the router 100. The management PC 303 accordingly locates the symbols of the devices having the wireless connection interface at the position closer to the symbol of the router 100 in the y direction, in order to clearly identify whether each device is connected with or not connected with the router 100. The order of locating the symbols of the devices having the wireless connection interface at the position closer to the symbol of the router 100 according to this embodiment corresponds to the preset order in the claims.

The respective symbols are connected by different line types corresponding to the different connection interface types. This allows clear differentiation among the connection interface types for the respective devices. The connection lines between the symbols are also displayed corresponding to the actual connections between the devices. More specifically, for example, the symbol of the router 100 and the symbol of the wireless LAN access point 304 are directly connected by a broken line. The symbols of the two personal computers 311 and 312 are, however, not directly connected with the symbol of the router 100 but are directly connected with the wireless LAN access point 304 by broken lines. Displaying the connection lines between the symbols corresponding to the actual connections between the devices enables the user to readily understand the actual connection configuration.

As shown in FIG. 8, information showing the operating condition of each device is displayed at the position corresponding to the symbol of the device (i.e., the position adjacent to the symbol of the device in the horizontal direction) in the operating condition display area AR2. More specifically, for example, information showing that 80% of the capacity of the hard disk 126 is being used and information showing that the mobile communication control circuit DP1 is active (ON) and is during communication are displayed at the position corresponding to the symbol of the router 100. In another example, a symbol representing that the router 100 receives the “high” signal strength from the wireless LAN access point 304 is displayed at the position corresponding to the symbol of the wireless LAN access point 304. Information showing that the printer 342 is being used by the user B (i.e., is performing a print job sent from the user B) is displayed at the position corresponding to the symbol of the printer 342.

As described above, arraying the symbols of the respective devices in the vertical direction enables the space for displaying the operating condition of each device to be provided adjacent to the symbol of the device in the horizontal direction. This enables the user to readily understand the connection configuration of the respective devices, together with the operating conditions of the respective devices. The system configuration map m1 shown in FIG. 8 corresponds to the connection configuration map in the claims.

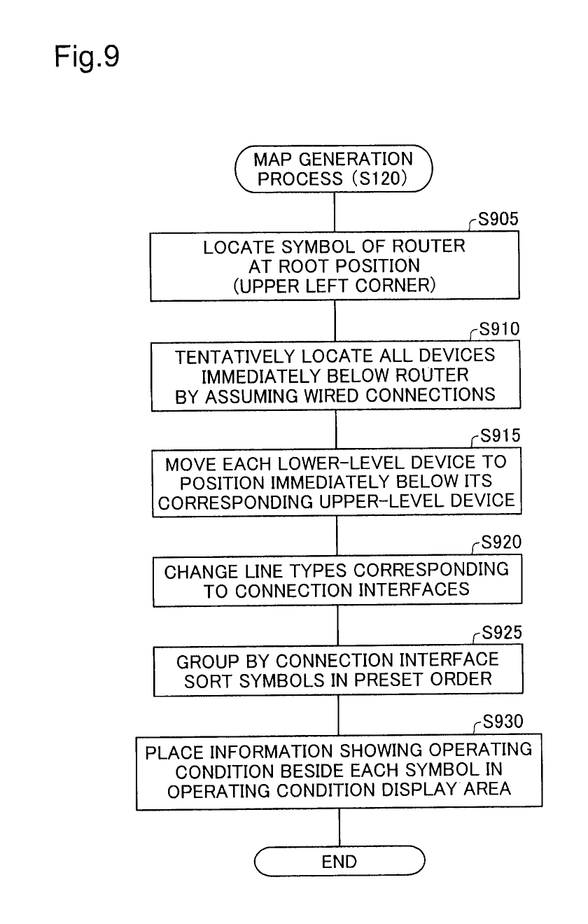

The map generation process to generate the system configuration map m1 shown in FIG. 8 is described below. FIG. 9 is a flowchart showing the detailed procedure of step S120 shown in FIG. 5.

The map generator 11b first locates the symbol of the router 100 at the root position (step S905). The symbol of the router 100 is located at the upper left corner of the window W1 as shown in FIG. 8, and this position corresponds to the root position according to this embodiment. The device name (router) of the router 100 is written inside the symbol.

The map generator 11b tentatively locates all the devices, from which the configuration information has been obtained, immediately below the symbol of the router 100 on the assumption of the wired connection (LAN connection) (step S910). The map generator 11b then refers to the obtained configuration information (lower-level device list) and moves the symbol of each device identified as a lower-level device to the position immediately below the symbol of its corresponding upper-level device (step S915).

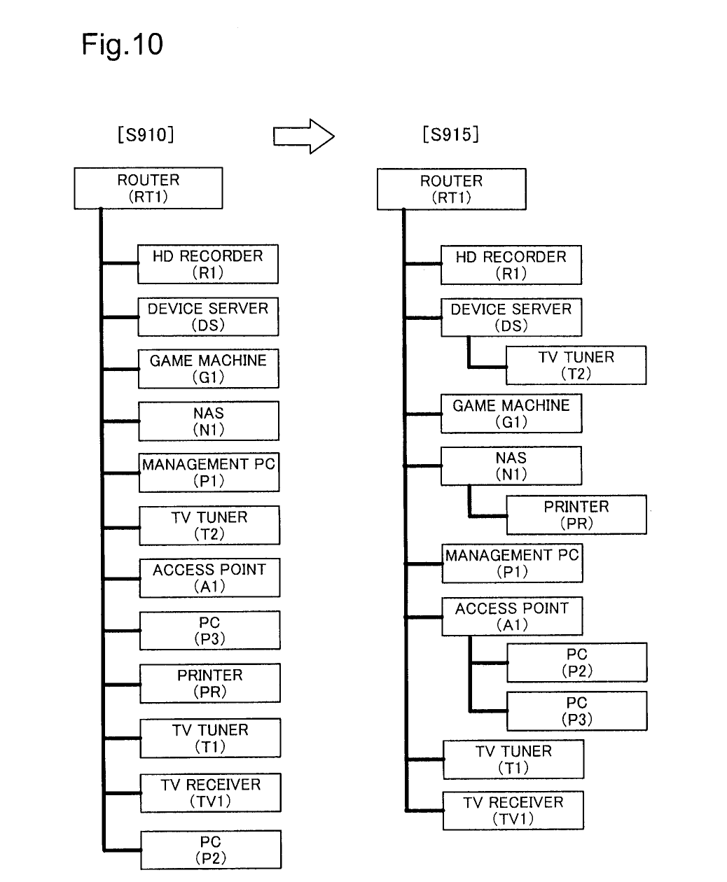

FIG. 10 illustrates the system configuration maps after the processing of step S910 and the processing of step S915 shown in FIG. 9. The left drawing of FIG. 10 shows the system configuration map after the processing of step S910, and the right drawing shows the system configuration map after the processing of step S915. As shown by the left drawing of FIG. 10, the symbols of the respective devices are arrayed in the vertical direction after the processing of step S910. As shown by the right drawing of FIG. 10, the symbols are rearranged to show which of the devices has a lower-level device and what is the lower-level device after the processing of step S915.

Referring back to FIG. 9, after step S915, the map generator 11b changes the line types between the respective devices corresponding to the connection interface types (step S920).

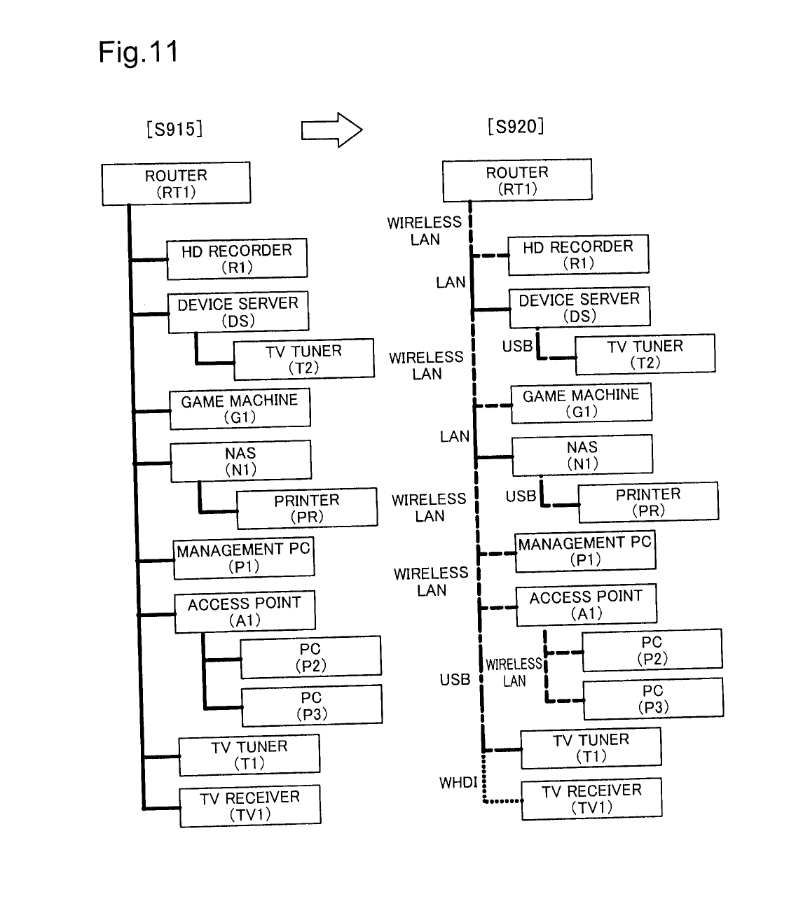

FIG. 11 illustrates the system configuration maps after the processing of step S915 and the processing of step S920 shown in FIG. 9. The left drawing of FIG. 11 shows the system configuration map after the processing of step S915, and the right drawing shows the system configuration map after the processing of step S920. The left drawing of FIG. 11 is identical with the right drawing of FIG. 10. As shown in the right drawing of FIG. 11, the lines connecting the devices are expressed by the different line types corresponding to the different connection interfaces after the processing of step S920.

Referring back to FIG. 9, after step S920, the map generator 11b groups the symbols of the devices by the connection interface with the router 100 while keeping the connection relationships between the devices and their lower-level devices, and sorts (rearranges) the symbols in a preset order (step S925).

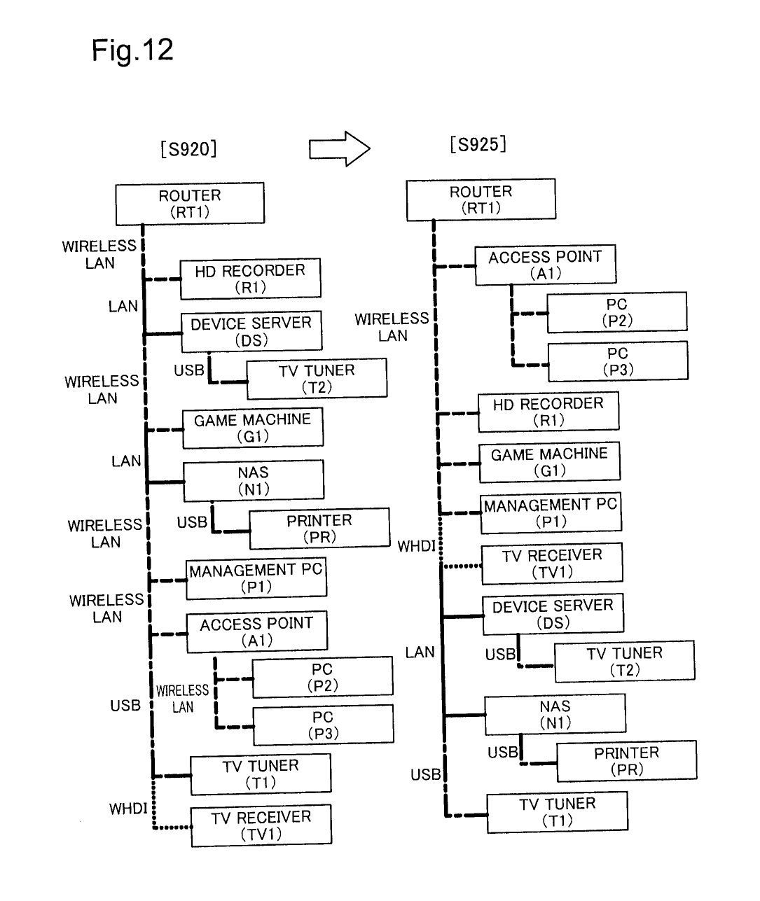

FIG. 12 illustrates the system configuration maps after the processing of step S920 and the processing of step S925 sown in FIG. 9. The left drawing of FIG. 12 shows the system configuration map after the processing of step S920, and the right drawing shows the system configuration map after the processing of step S925. The left drawing of FIG. 12 is identical with the right drawing of FIG. 11. The right drawing of FIG. 12 matches the display in the connection mode display area AR1 of the system configuration map m1 shown in FIG. 8. As shown in the left drawing of FIG. 12 (right drawing of FIG. 11), the devices having different connection interfaces with the router 100 may be arranged adjacent to each other after the processing of step S920. As shown in the right drawing of FIG. 12, however, the devices are grouped by the connection interface with the router 100 after the processing of step S925.

In the system 500 described above, the management PC 303 indirectly obtains the configuration information of a device of interest (for example, printer 342) that is not directly connected with the router 100 via a device (for example, device server 331) directly connected with both the router 100 and the device of interest. This facilitates management of a plurality of devices connected by not only the connection interfaces for direct connection with the router 100 but various other connection interfaces. The centralized management of the respective devices by the management PC 303 does not require a management device (management software) provided for each connection interface type. This saves the cost for constructing the system 500 and does not require the user to learn how to use a plurality of management devices (management software), thus ensuring easy introduction into the home or small business.

In response to the query for configuration information from the management PC 303, the router 100 creates a lower-level device list including the IP address of each lower-level device and information showing whether each lower-level device has any further lower-level device and sends the created lower-level device list in addition to the own configuration information to the management PC 303. The management PC 303 refers to this lower-level device list to identify each lower-level device and queries each lower-level device for the configuration information of its further lower-level device.

In response to the query for configuration information from the management PC 303, the device that has any lower-level device and is not directly connected with the router 100 obtains the configuration information of the lower-level device, creates a lower-level device list and sends the own configuration information and the created lower-level device list to the management PC 303 (steps S310 to S320). Even when the bus interface is used for the connection interface between the device with any lower-level device and its lower-level device and thereby the management PC 303 can not directly obtain the configuration information of the lower-level device, this enables the configuration information of the lower-level device to be obtained via the device having the lower-level device.

The management PC 303 queries only the router 100 and each of the devices that is not directly connected with the router 100 and has any lower-level device for configuration information. This advantageously relieves the processing load of the management PC 303, compared with querying all the devices included in the system 500 for configuration information. Especially the router 100 has a number of connection interfaces, so that it is highly probable that the router 100 has already obtained the configuration information of each device connected via some connection interface (for example, USB) by the initialization sequence on the connection to the router 100. Querying the router 100 for the configuration information advantageously shortens the time required for obtaining the configuration information.

The symbols of the respective devices are arranged in the hierarchical manner in the system configuration map m1, so that the user can readily understand the connections of the respective devices. The grouped display of the symbols of the respective devices by the connection interface type with the router 100 enables the user to easily understand how many devices are connected for each connection interface. The symbol of a device having the wireless connection interface with the router 100, which does not allow easy detection of the connection or non-connection of the device with the router 100, is arranged at the position closer to the symbol of the router 100 than the symbol of a device having the wired connection interface with the router 100, so as to clearly differentiate between the connection and non-connection of the device with the router 100. Different line types corresponding to different connection interface types are used for connecting the symbols, so as to clearly differentiate among the connection interface types for the respective devices. Displaying the connection lines between the symbols corresponding to the actual connections between the devices enables the user to readily understand the actual connection configuration.

Arraying the symbols of the respective devices in the vertical direction enables the space for displaying the operating condition of each device to be provided adjacent to the symbol of the device in the horizontal direction. Additionally, displaying the information on the operating condition of each device (symbol or character string) at the position corresponding to the symbol of the device enables the user to understand the operating condition of the device at first sight.

### B. Second Embodiment

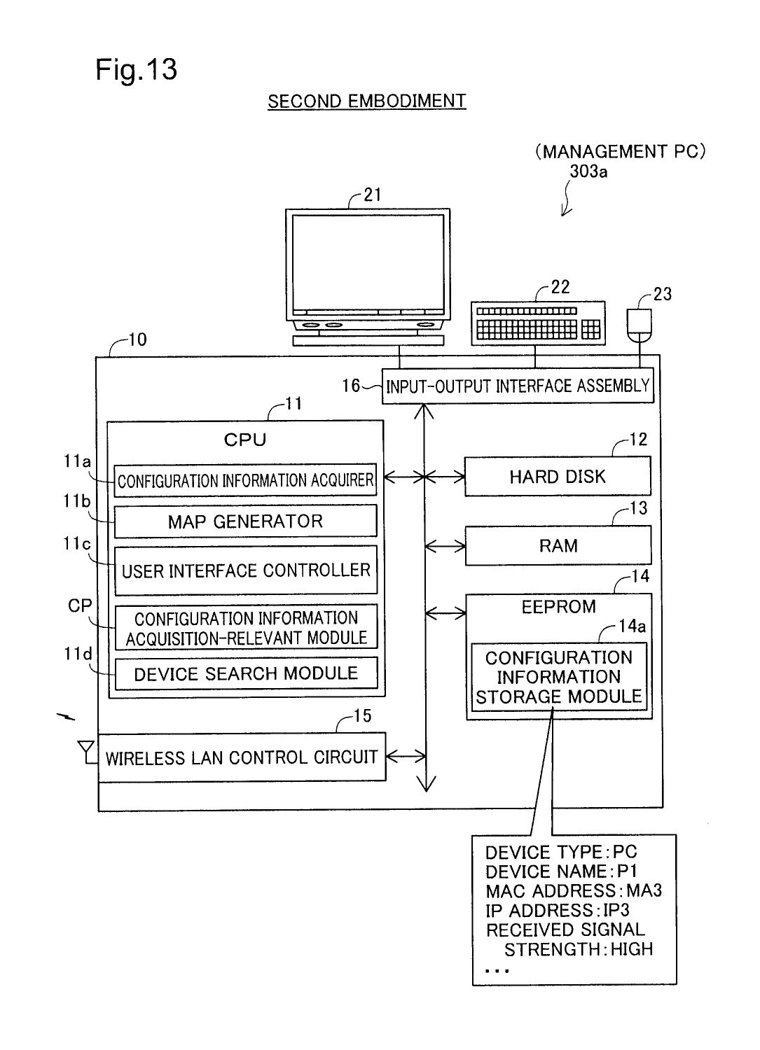

FIG. 13 schematically illustrates the structure of a management PC according to a second embodiment. The management PC 303a of the second embodiment differs from the management PC 303 of the first embodiment shown in FIG. 3 in the additional function as a device search module 11d, but otherwise has the similar structure to that of the management PC 303. According to the first embodiment, the management PC 303 specifies each device, based on the lower-level device list notified by the router 100. According to the second embodiment, on the other hand, the management PC 303a searches for each device. The device structures and the processing flows in the system of the second embodiment other than this device structure and the relevant processing flow are identical with those of the first embodiment.

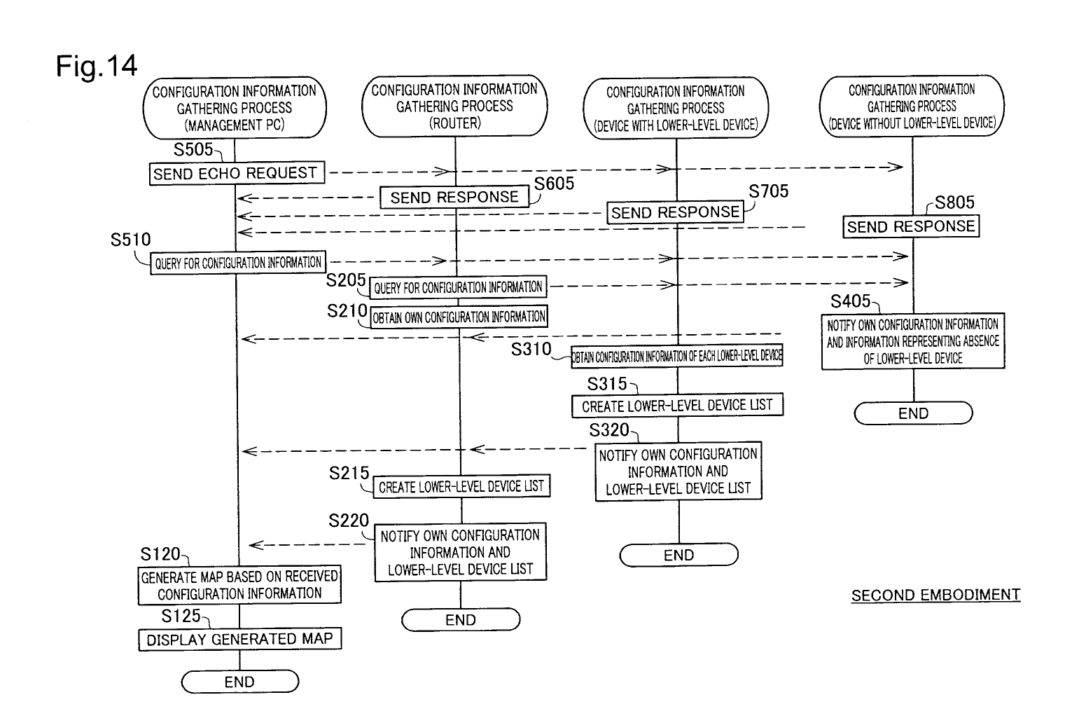

FIG. 14 is a sequence diagram showing a procedure of configuration information gathering process according to the second embodiment. The leftmost flow shows the processing flow of the management PC 303a. The second left flow, the third left flow and the rightmost flow respectively show the processing flow of the router 100, the processing flow of a device with any lower-level device but the router 100 and the processing flow of a device without any lower-level device.

The device search module 11d of the management PC 303a sends an echo request to all the devices included in the system 500 (step S505). The echo request requires only a simple response and checks whether each device is reachable online, based on the response or no response to the echo request. This embodiment uses ICMP (Internet Control Message Protocol) ping (packet internet grouper) as the response request. In this application, one available method may set the IP addresses of the respective devices in the management PC 303a. The method of sending ping is, however, not restricted to the method of setting the IP addresses of the respective devices in the management PC 303a and sending ping to the IP addresses as the destinations but may be the method of setting IP addresses and subnet masks belonging to a network used in the system 500 and sending ping to all possible IP addresses that may be allocated to this network. Another available method may query the router 100 for a network address and send ping to all possible IP addresses that may be allocated to the network.

When receiving the echo request, the wired LAN control circuit 170 of the router 100 sends a response to the management PC 303a (step S605). Similarly, when receiving the echo request, the device with any lower-level device and the device without any lower-level device sends a response to the management PC 303a (step S705 or step S805). When ping is used as the echo request of step S505, only the devices that are capable of interpreting ICMP among the devices included in the system 500 send the response at step S705 or at step S805.

The configuration information acquirer 11a of the management PC 303a queries each of the devices, which have sent a response to the echo request of step S505, for configuration information (step S510).

After sending the response to the management PC 303a (after step S605), the router 100 performs the processing of steps S205, S210, S215 and S220 described above in the first embodiment. After sending the response to the management PC 303a (after step S705), the device with any lower-level device performs the processing of steps S310, S315 and S320 described above. After sending the response to the management PC 303a (after step S805), the device without any lower-level device performs the processing of step S405 described above.

The management PC 303a receives the configuration information or the lower-level device list from each of the devices and performs the processing of steps S120 and S125 described above to display the system configuration map on the display 21.

In the system of the second embodiment described above, the management PC 303a has the similar advantageous effects to those of the management PC 303 of the first embodiment. Additionally, the direct query for configuration information from the management PC 303a to each device enables the configuration information to be obtained from the respective devices except the router 100 even in the case of a failure in the router 100.

### C. Third Embodiment

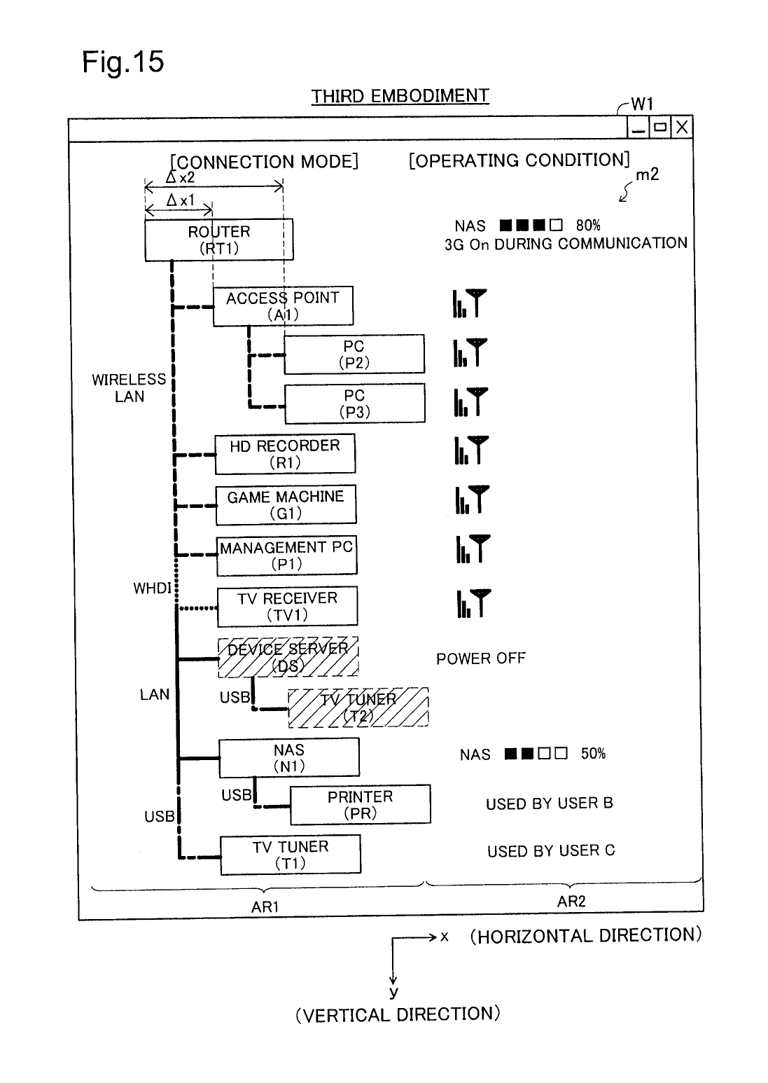

FIG. 15 illustrates a system configuration map displayed on the display according to a third embodiment. The system of the third embodiment adopts a different display format of the system configuration map from that of the system 500 of the first embodiment, but otherwise has the same configuration as that of the first embodiment. The system of the first embodiment displays the operating conditions of the respective devices included in the system 500 in the operating condition display area AR2; for example, when a device is powered off, information representing the power-off state is displayed in the form of a character string in the operating condition display area AR2.

The system of the third embodiment, on the other hand, changes the display of the symbol of each device according to a change in its operating condition, while displaying the operating condition of the device in the operating condition display area AR2. More specifically, for example, when the device server 331 is powered off, the system of the third embodiment grays out the symbol of the device server 331, while displaying a character string “power off” in the operating condition display area AR2 of a system configuration map m2 as shown in FIG. 15. The symbol of the TV tuner 341 connected with the device server 331 is simultaneously grayed out. The symbol of the TV tuner 341 is also grayed out, because the management PC 303 is not informed of the operating condition of the TV tuner 341, which is the lower-level device of the device server 331, after the power-off of the device server 331.

When the device is powered on again, it is preferable to return the grayed-out symbol of the device to its original display.

In the system of the third embodiment described above, the management PC has the similar advantageous effects to those of the management PC 303 of the first embodiment. The additional change in display of the symbol of each device according to a change in its operating condition further facilitates the user's understanding of the operating conditions of the respective devices.

### D. Fourth Embodiment

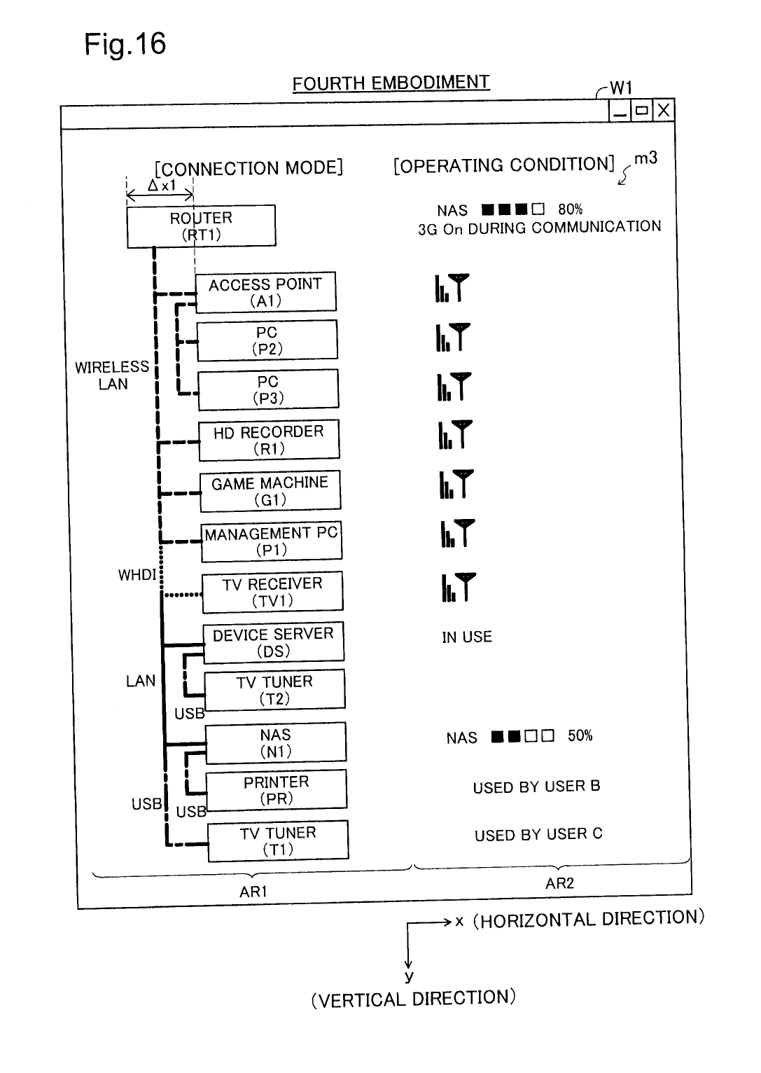

FIG. 16 illustrates a system configuration map displayed on the display according to a fourth embodiment. The system of the fourth embodiment adopts a different display format of the system configuration map from that of the system 500 of the first embodiment, but otherwise has the same configuration as that of the first embodiment. According to the first embodiment, the symbols of the respective devices including the router 100 are arranged in the hierarchical manner in the system configuration map m1 displayed on the display 21. According to the fourth embodiment, on the other hand, the symbols of the respective devices other than the router 100 are arranged on an identical hierarchical level.

More specifically, in a system configuration map m3 of the fourth embodiment shown in FIG. 16, the symbols of the respective devices other than the router 100 are all located at offset Δx1 right in the x direction (horizontal direction) from the symbol of the router 100 to be arranged on the same hierarchical level. Like the first embodiment, the connection lines between the symbols are displayed corresponding to the actual connections between the devices, so that the user can readily understand the actual connection configuration. According to this embodiment, the symbol (for example, symbol A1) of the device (first device) directly connected with the router 100 is located at the position having a shorter distance in the y direction (vertical direction) from the symbol of the router 100 than the symbol (for example, symbol P2) of the device (second device) that is connected with the first device and has a greater number of devices intervening before the router 100. The symbol of the first device is accordingly located at the position closer to the symbol of the router 100 than the symbol of the second device. This enables the user to sensuously and easily understand the connections between the respective devices.

In the system of the fourth embodiment described above, the management PC has the similar advantageous effects to those of the management PC 303 of the first embodiment.

### E. Modifications

The disclosure is not limited to the above embodiments, but a multiplicity of variants and modifications may be made to the embodiments without departing from the scope of the invention. Some examples of possible modifications are described below.

### E1. Modification 1

The method of setting the IP addresses of the respective devices in advance in the management PC 303a or the method of determining all the possible IP addresses that may be allocated to a network in the system 500 as the destination IP addresses is adopted to determine the IP addresses of the destinations of the echo request, such as ping according to the second embodiment, but the invention is not limited to such methods. The router 100 also functions as a DHCP server and may thus query the router 100 for IP addresses allocated to the respective devices as DHCP clients and determine the IP addresses obtained as the reply to the query as the destination IP addresses of the echo request. In an application including a separate DHCP server from the router 100, the method may query the DHCP server, instead of the router 100, for the allocated IP addresses.

### E2. Modification 2

According to the first embodiment, the management PC 303 (configuration information acquirer 11a) queries each lower-level device of the router having any lower-level device for configuration information. According to the second embodiment, the management PC 303a queries all the devices responding to the echo request for configuration information. The disclosure is, however, not limited to these methodologies. According to another methodology, the management PC may query the router 100 for configuration information, and the router 100 may obtain configuration information of all the devices and collectively notify the management PC of the obtained configuration information. More specifically, the router 100 may perform the processing of steps S110 and S115 described in the first embodiment. Similarly, the router 100 may perform the processing of steps S505 and S510 described in the second embodiment.

### E3. Modification 3

The management PC 303 (configuration information acquirer 11a) checks whether each device has any lower-level device (step S110), based on the settings in the lower-level device presence/absence field of the lower-level device list according to the first embodiment, but the disclosure is not limited to this methodology. According to another methodology, device types that are generally not expected to have any lower-level device may be set in advance in the management PC 303, and the above checking may be based on the comparison between the preset device types and the settings in the device type field of the lower-level device list. The device types that are not expected to have any lower-level device may include, for example, “hard disk recorder”, “TV receiver” and “printer”. This methodology does not require acquisition of the information on the presence/absence of any lower-level device from the respective devices, thus reliving the processing load and reducing the data size of the lower-level device list.

### E4. Modification 4

In the embodiments described above, part of the devices connected with the router 100 may be omitted. A plurality of devices are connected to the router 100 in the above embodiment, but only one of these device may be connected to the router 100. Any lower-level device of the devices other than the router 100 (two personal computers 311 and 312, TV tuner 341 and printer 342 shown in FIG. 1) does not have its lower-level device in the above embodiments, but may further have its lower-level device.

The connection interfaces between the respective devices adopted in the above embodiment include the wired LAN interface (LAN interface conforming to the IEEE802.3 standard), the wireless LAN interface (LAN interface conforming to the IEEE802.11b/g standard), the WHDI and the USB2.0, but the disclosure is not limited to these interfaces. Any arbitrary interfaces may be adopted for the network interfaces; for example, an interface conforming to the IEEE802.3z or IEEE802.3ab standard as the wired LAN interface and an interface conforming to the IEEE802.11a or IEEE802.11n standard as the wireless LAN interface. Any arbitrary interfaces may also be adopted for the bus interfaces; for example, an interface conforming to the USB1.1 or USB3.0 protocol as the USB interface, a serial transfer interface, such as an interface conforming to the IEEE1394 or PCI Express (PCIe) standard, a video/sound input/output interface, such as an HDMI (High-Definition Multimedia Interface) or WirelessHD (WiHD) interface, and a near field communication interface, such as a Zigbee, Bluetooth or IrDA interface. In an application adopting a device of collecting pulse data sent by Zigbee from a small pulse monitor in the system 500, the pulse data may be displayed as information on the operating condition of the pulse monitor in the system configuration map.

### E5. Modification 5

The information showing the operating conditions of the respective devices displayed in the system configuration map in the above embodiments includes, for example, the use capacity of the hard disk, the received signal strength and the name of the user currently using the device as shown in FIG. 8, but the disclosure is not restricted to such information. For example, the information may be the remaining ink level or the total number of printed pages with respect to the printer or may be the firmware version of each device. The device name is displayed as the information identifying each device in the system configuration map, but the disclosure is not limited to such information. Any arbitrary information identifying each device, such as an IP address or a MAC address, may be displayed, in place of or in addition to the device name, in the system configuration map. In general, information including at least device identification information, device type and connection interface type may be adopted as the configuration information in the management device of the disclosure.

### E6. Modification 6

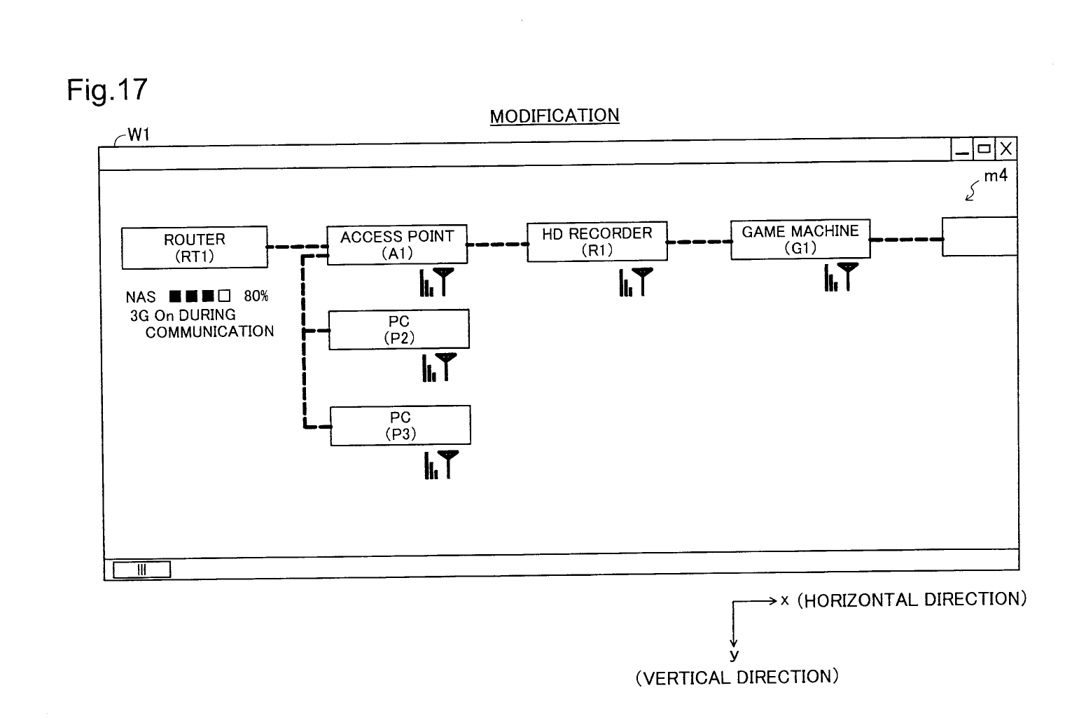

The display format of the system configuration map is not limited to those shown in the above embodiments, but the invention may adopt any other suitable display format. FIG. 17 illustrates an exemplary system configuration map displayed on the display of the management PC according to one modification. A system configuration map m4 shown in FIG. 17 differs from the system configuration map m1 shown in FIG. 8 in that the symbols of the respective devices are arrayed in the x direction (horizontal direction) from the router 100 as the starting point, that the symbol of a lower-level device of a device of interest is located below the symbol of the device of interest in the vertical direction and that the information showing the operating condition of each device is displayed below the symbol of the device in the vertical direction, but otherwise has the similar structure to that of the system configuration map m1. Although only part of the symbols displayed in the window W1 are shown in FIG. 17, the whole system configuration map m4 is made visible by scrolling the window W1 rightward. This display format according to the modification also clarifies the hierarchical structure of the respective devices and has the other similar advantageous effects to those of the first embodiment. In general, the management device of the disclosure may have the display unit configured to array devices directly connected with the router 100 by wireless connection or by wired connection in a predetermined direction from the router 100 as the starting point. According to this modification, the symbol (for example, symbol A1) of the device (first device) directly connected with the router 100 is located at the position having a shorter distance in the y direction (vertical direction) from the symbol of the router 100 than the symbol (for example, symbol P2) of the device (second device) that is connected with the first device and has a greater number of devices intervening before the router 100. The symbol of the first device is accordingly located at the position closer to the symbol of the router 100 than the symbol of the second device. This enables the user to sensuously and easily understand the connections between the respective devices. In any of the above embodiments and modifications, as long as the symbol (for example, symbol A1) of the device (first device) directly connected with the router 100 is located at the position having a shorter distance in at least a predetermined direction from the symbol of the router 100 than the symbol (for example, symbol P2) of the device (second device) that is connected with the first device and has a greater number of devices intervening before the router 100, the symbols may have any positional relationship in another direction. For example, in the system configuration map m1 shown in FIG. 8, the symbol of the first device (for example, symbol A1) is located on the left of (i.e., at the position closer to the symbol of the router 100 than) the symbol of the second device (for example, symbol P2) in the x direction, so that the symbol of the second embodiment may be located above (i.e., at the position closer to the symbol of the router 100 than) the symbol of the first device in the y direction.

The symbols of the devices having the wireless connection interface with the router 100 are located at the position closer to the symbol of the router 100 in the y direction than the symbols of the devices having the wired connection interface with the router 100 in the system configuration map according to the above embodiments, but the disclosure is not limited to this arrangement. For example, the symbols of the devices having the wired connection interface with the router 100 may be located at the position closer to the symbol of the router 100 in the y direction than the symbols of the devices having the wireless connection interface with the router 100. In another example, the symbols of the devices with any lower-level device may be located at the position closer to the symbol of the router 100 in the y direction than the symbols of the devices without any lower-level device. This arrangement clearly differentiates the devices with any lower-level device.

The symbol of a device is grayed out to indicate the power-off state of the device according to the third embodiment, but another suitable display format may be adopted to indicate a change in operating condition of the device. For example, the shape of the symbol may be changed according to a change in operating condition (for example, rectangle in the normal working state and triangle in the power-off state), or the symbol may be shaded or non-shaded with a change in operating condition (for example, shaded in the power-on state and non-shaded in the power-off state). In place of or in addition to the symbol of each device, the display format of the connection line between the symbols of the devices may be changed according to a change in operating condition. Specifically, for example, the connection line for a device in the power-off state may be displayed with the lower saturation than that of the connection line for the same device in the power-on state. In another example, the lighted (normal display format) connection line in the power-on state may be flashed in the power-off state.

The information showing the operating condition of each device is displayed together with the symbol of the device in the system configuration map according to the above embodiments, but the display of the information showing the operating condition may be omitted. The device type and the device name of each device are shown inside the symbol of each device in the system configuration map according to the above embodiments, but may alternatively be shown outside the symbol of each device. In the latter case, displaying the device type and the device name of each device in correlation to the symbol of the device allows identification of the device in the system configuration map. Instead of both the device type and the device name of each device, only one of the device type and the device name may be displayed for identification of the device.

### E7. Modification 7

The system configuration map is displayed on the display 21 of the management PC 303 or 303a according to the above embodiments, but the disclosure is not limited to this display 21. For example, the system configuration map may be displayed on a display of either of the two personal computers 311 and 312. In another example, the system configuration map may be displayed on the TV receiver 321. In an application of the router 100 having a display device, such as a liquid crystal display, the system configuration map may be displayed on the display device. Displaying the system configuration map on the TV receiver 321 allows enlarged display of the system configuration map. Displaying the system configuration map on the display device of the router enables the connection configuration of the respective deices to be readily checked at work in the router 100 (for example, insertion or removal of a cable).

The functional blocks of gathering the configuration information and generating and displaying the system configuration map are implemented by the management PC 303 or 303a according to the above embodiments, but the disclosure is not limited to this implementation. For example, the management PC 303 may be omitted, and the router 100 may serve as the functional blocks to gather the configuration information and generate and display the system configuration map. In this application, the router 100 may be structured to have the functional blocks of the management PC 303 or the management PC 303a. In an application of the system including a different router separate from the router 100, this different router may be structured to have the functional blocks of the management PC 303 or 303a.

### E8. Modification 8

All the devices directly connected with the router 100 by wireless connection or by wired connection have the configuration information acquisition-relevant module CP according to the above embodiments, but some of such devices may be structured without the configuration information acquisition-relevant module CP. In the latter case, the device without the configuration information acquisition-relevant module CP does not perform the processing of either step S305 or step S405, so that the router 100 does not add this device to its lower-level device list. In the system of the second embodiment, however, the device without the configuration information acquisition-relevant module CP adopting TCP/IP as the communication protocol can send a response to the echo request (ping), so that the management PC 303a can recognize the presence of the device. In this case, the symbol of the device with its IP address instead of the device name may be displayed immediately below the symbol of the router 100 in the system configuration map. The user may be allowed to add the device type and the device name of the device obtained elsewhere to the displayed symbol of the device. The user may also be allowed to move the symbol of the device to any adequate location in the system configuration map. These variations enable the management PC 303 or the management PC 303a to readily manage even the devices without the configuration information acquisition-relevant module CP.

Each device creates and sends its lower-level device list as the reply to the query from the router 100 or from the management PC 303 or 303a according to the above embodiments, but the disclosure is not limited to this methodology. For example, the wireless LAN access point may send its own wireless LAN association list (enumeration of MAC addresses of the connected devices), instead of the lower-level device list, to the router 100 or to the management PC 303 or 303a. In this application, the router 100 or the management PC 303 or 303a can obtain at least part of the configuration information of each device, based on the MAC address of the device included in the obtained association list. More specifically, the router 100 or the management PC 303 or 303a may adopt RARP (Reverse Address Resolution Protocol) to obtain the IP address of each device, based on the MAC address of the device included in the obtained association list.

According to another modification, each device adopting the network interface for the connection interface to its lower-level device may send address information (for example, MAC address, IP address or subnet mask) of its lower-level device, instead of the lower-level device list, to the router 100 or to the management PC 303 or 303a, while each device adopting the bus interface for the connection interface to its lower-level device may send the lower-level devise list. The management device informed of the address information can directly obtain the configuration information via the network from the lower-level device connected by the network interface. The management device cannot, however, directly obtain the configuration information via the network from the lower-level device connected by the bus interface. Receiving the lower-level device list output from the device adopting the bus interface enables the management device to obtain at least the information recorded in the lower-level device list with respect to the lower-level device.

### E9. Modification 9

The configuration information gathering process is performed at regular intervals after the start-up of the management PC 303 or 303a according to the above embodiments, but the disclosure is not limited to this methodology. For example, the configuration information gathering process may be performed automatically only at the start-up of the management PC 303 or 303a and may be performed subsequently in response to the user's execution instruction given to the management PC 303 or 303a. According to another modification, the configuration information gathering process may be triggered by a change of the configuration information in any of the devices.

### E10. Modification 10

The echo request sent by the device search module 11d is ping according to the second embodiment, but the disclosure is not limited to this methodology. For example, specific data set in advance between the configuration information acquisition-relevant modules CP may be exchanged for the echo request and its response.

### E11. Modification 11

According to the second embodiment, when the router 100 fails to respond to the echo request, for example, due to a failure or a trouble, the system configuration map cannot be generated because of the failed first operation step (step S905) of the map generation process shown in FIG. 9. In this case, a preset symbol showing the root may be located at the root position, instead of the symbol of the router 100 at step S905.

The symbol of the router 100 is located at the root position in the system configuration map according to the above embodiments, but the disclosure is not limited to this symbol. For example, the symbol of a device set as a default gateway in the management PC 303 or 303a may be located at the root position. When no default gateway is set in the management PC 303 or 303a, a dummy symbol may tentatively be located at the root position.

### E12. Modification 12

The devices connected by a wired LAN or by a wireless LAN are connected directly according to the above embodiments, but the disclosure is not limited to this connection configuration. A device relaying layer 2 frames may intervene between the devices, and the devices may be connected indirectly via this device.

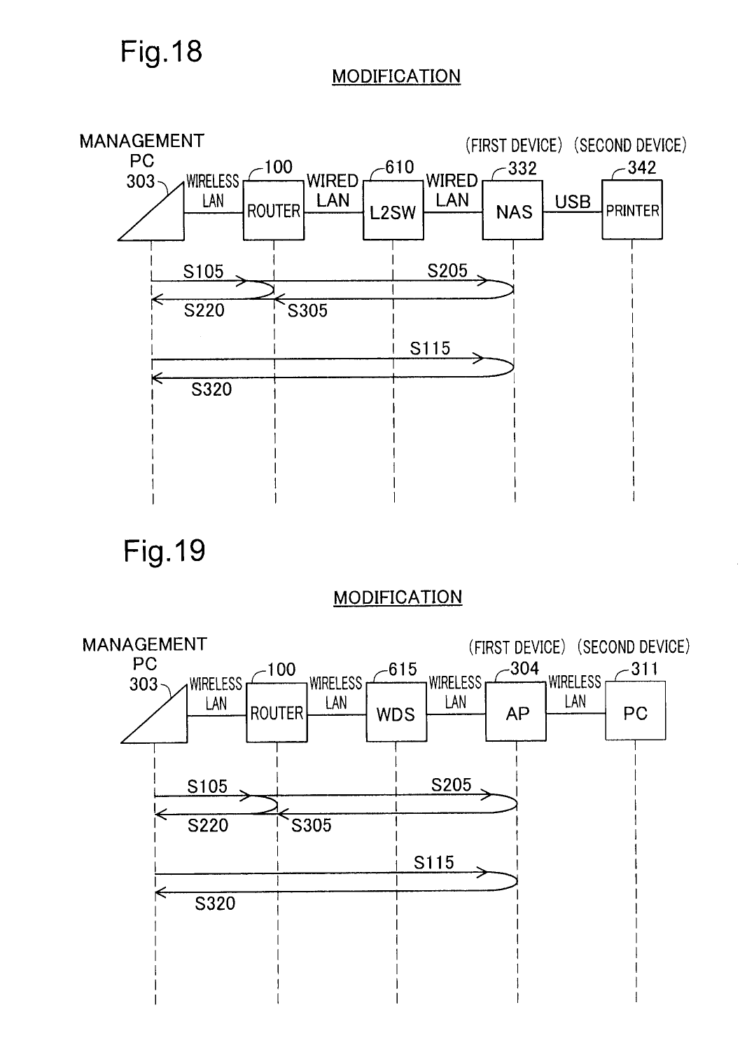

FIG. 18 schematically illustrates one example of the system connection configuration according to one modification. Only the connections between the router 100, the NAS 332 and the printer 342 are shown in FIG. 18, while the connections between the other devices shown in FIG. 1 are omitted. As shown in FIG. 18, a layer 2 switch 610 may intervene between the router 100 and the NAS 332. According to this connection configuration, the packets involved in the query for configuration information output from the router 100 (step S205) and its response (step S305) and the packets involved in the query for configuration information output from the management PC 303 (step S115) and its response (step S320) in the first embodiment do not terminate at the layer 2 switch 610 but reach the destination device (NAS 332, wireless LAN access point 304, router 100 or the management PC 303). The system configuration map displayed on the management PC 303 according to the connection modification of FIG. 18 is identical with the system configuration map m1 of the first embodiment shown in FIG. 8. In other words, the system configuration map does not include the display of a symbol representing the layer 2 switch 610. The layer 2 switch 610 is used for one-to-one connection between the router 100 and the NAS 332 in the connection configuration shown in FIG. 18, but may be connected with another device (for example, device server 331) in addition to the router 100 and the NAS 332 for one-to-n connection between the devices.

FIG. 19 schematically illustrates another example of the system connection configuration according to another modification. Only the connections between the router 100, the wireless LAN access point 304 and the personal computer 311 are shown in FIG. 19, while the connections between the other devices shown in FIG. 1 are omitted. As shown in FIG. 19, a WDS (Wireless Distribution System) device 615 may intervene between the router 100 and the wireless LAN access point 304. The WDS device 615 serves for layer-2 relay of communication between wireless LAN access points. According to this connection configuration, the packets involved in the query for configuration information output from the router 100 (step S205) and its response (step S305) and the packets involved in the query for configuration information output from the management PC 303 (step S115) and its response (step S320) in the first embodiment do not terminate at the WDS device 615 but reach the destination device (wireless LAN access point 304, router 100 or the management PC 303).

The system configuration map displayed on the management PC 303 according to the connection modification of FIG. 19 is identical with the system configuration map m1 of the first embodiment shown in FIG. 8. In other words, the system configuration map does not include the display of a symbol representing the WDS device 615. The WDS device 615 is used for one-to-one connection between the router 100 and the wireless LAN access point 304 in the connection configuration shown in FIG. 19, but may be connected with another device (for example, another access point (not shown)) in addition to the router 100 and the wireless LAN access point 304 for one-to-n connection between the devices. The layer 2 frame relay device (layer 2 switch or WDS device) may not be located between the router 100 and another device but may be located between devices other than the router 100.

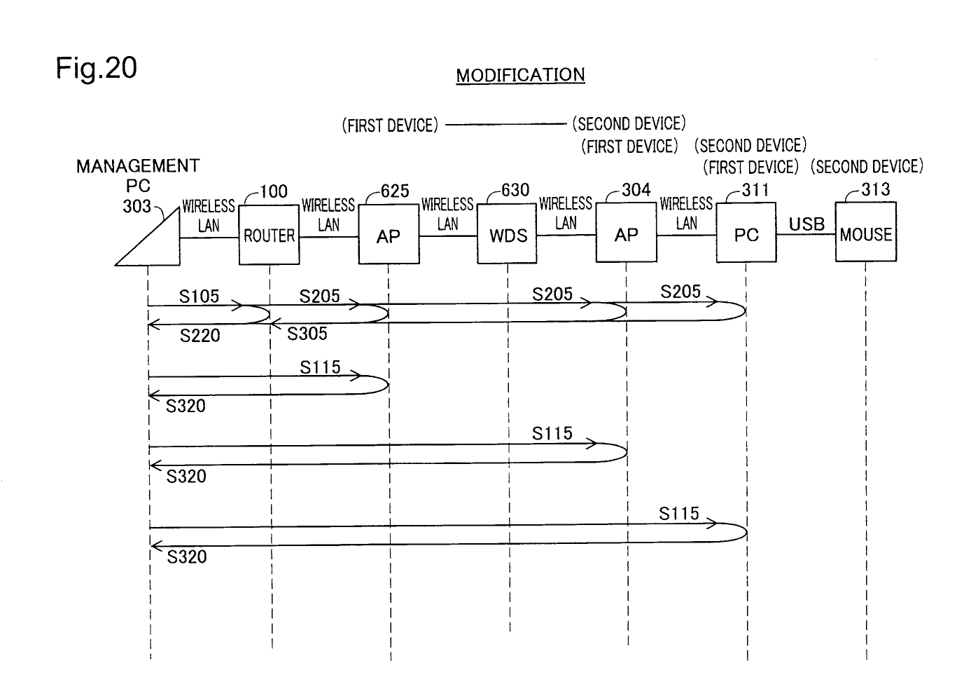

FIG. 20 schematically illustrates another example of the system connection configuration according to another modification. Only the connections between the router 100, the wireless LAN access point 304, the personal computer 311 and the mouse 313 are shown in FIG. 20, while the connections between the other devices shown in FIG. 1 are omitted. The connection configuration shown in FIG. 20 differs from the connection configuration shown in FIG. 7 in addition of a wireless LAN access point 625 and a WDS device 630 between the router 100 and the wireless LAN access point 304, but otherwise has the similar configuration to that shown in FIG. 7. The wireless LAN access point 625 has the same functions as those of the wireless LAN access point 304. The WDS device 630 connects the two wireless LAN access points 304 and 625. According to this connection configuration, the packets involved in the query for configuration information output from the router 100 (step S205) and its response (step S305) and the packets involved in the query for configuration information output from the management PC 303 (step S115) and its response (step S320) in the first embodiment do not terminate at the WDS device 625 but reach the destination device (wireless LAN access point 304, personal computer 311, router 100 or the management PC 303).

In the system configuration shown in FIG. 20, in the pair of the wireless LAN access point 625 and the wireless LAN access point 304, the wireless LAN access pint 625 corresponds to the first device, while the wireless LAN access point 304 corresponds to the second device. In the pair of the wireless LAN access point 304 and the personal computer 311, the wireless LAN access point 304 corresponds to the first device, while the personal computer 311 corresponds to the second device. In the pair of the personal computer 311 and the mouse 313, the personal computer 311 corresponds to the first device, while the mouse 313 corresponds to the second device. The system configuration map displayed on the management PC 303 according to the connection modification of FIG. 20 is different from the system configuration map m1 of the first embodiment shown in FIG. 8. More specifically, the differences from the system configuration map m1 include the presence of a symbol representing the wireless LAN access point 625 between the symbols of the router 100 and the wireless LAN access point 304, the connections between these symbols by connection lines corresponding to the wireless LAN interface, the presence of a symbol representing the mouse 313 under the symbol of the personal computer 311 and the connection between these symbols by a connection line corresponding to the USB interface.

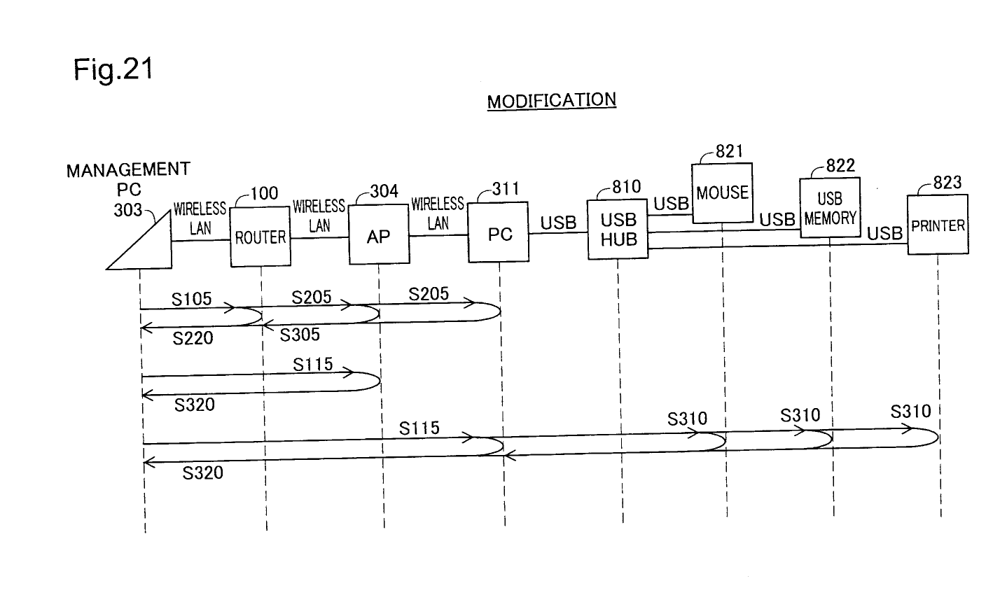

FIG. 21 schematically illustrates another example of the system connection configuration according to another modification. Like the connection configuration of FIG. 19, only the connections between the router 100, the wireless LAN access point 304 and the personal computer 311 are shown in FIG. 21, while the connections between the other devices shown in FIG. 1 are omitted. As shown in FIG. 21, unlike the first embodiment, a USB hub 810 is connected with the personal computer 311. The USB hub 810 has a plurality of ports (not shown) and is connected with the personal computer 311, a mouse 821, a USB memory 822 and a printer 823 at these ports. The devices connected with the USB hub 810 adopt the USB interface. When the configuration information gathering process of FIG. 5 is performed in this connection configuration, the personal computer 311 obtains the configuration information from the mouse 821, the USB memory 822 and the printer 823 at step S310. The USB hub 810, however, does not terminate but relays a packet for obtaining the configuration information and accordingly does not send its own configuration information to the personal computer 311.

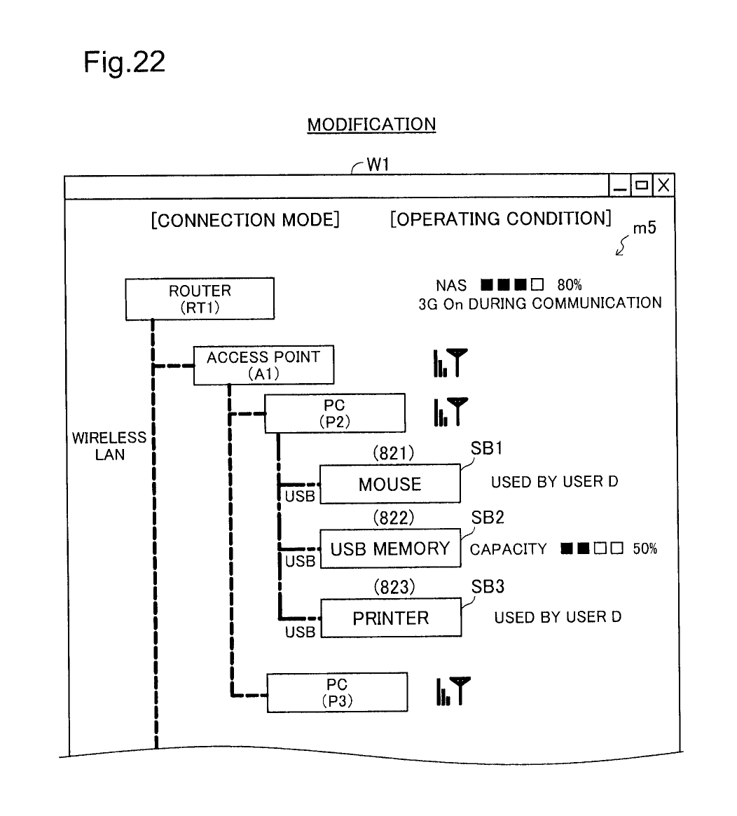

FIG. 22 illustrates one example of system configuration map displayed on the display of the management PC according to one modification. A system configuration map m5 shown in FIG. 22 is based on the connection configuration shown in FIG. 21. The system configuration map m5 differs from the system configuration map m1 of FIG. 8 in that symbols SB1, SB2 and SB3 respectively representing the mouse 821, the USB memory 822 and the printer 823 (FIG. 21) are located below the symbol of the personal computer 311 (P2), that the symbols SB1 to SB3 and the symbol of the personal computer 311 are connected by connection lines corresponding to the USB interface and that the operating conditions are displayed at the positions corresponding to the respective symbols SB1 to SB3, but otherwise has the similar structure to that of the system configuration map m1. For the convenience of explanation, only part of the system configuration map is shown in FIG. 22.

As described above, since the personal computer 311 is not notified of the configuration information of the USB hub 810 according to the connection configuration shown in FIG. 21, the management PC 303 cannot obtain the configuration information of the USB hub 810. The system configuration map m5 accordingly does not include a symbol representing the USB hub 810 as shown in FIG. 22.

### E13. Modification 13

In the embodiments described above, part of the software configuration may be replaced by the hardware configuration. On the contrary, part of the hardware configuration may be replaced by the software configuration.

### F. Other Aspects

According to an aspect of a method of managing system, the aspect is directed to a method of managing a system, wherein the method is executed by an apparatus having a display unit, wherein the system comprises a gateway device, a first device connected with the gateway device and a second device, wherein the second device has a greater number of devices intervening before the gateway device than the first device. The method comprises: (a) obtaining configuration information of the gateway device, configuration information of the first device and configuration information of the second device; and (b) displaying a connection configuration map based on the configuration informations wherein the connection configuration map includes a symbol of the gateway device, a symbol of the first device and a symbol of the second device on the display unit, wherein the connection configuration map is provided, such that the symbols of the gateway device, the first device and the second device are connected corresponding to actual connections between the gateway device, the first device and the second device, such that the symbol of the first device is located at a position having a shorter distance in a preset first direction from the symbol of the gateway device than the symbol of the second device, and such that connection interfaces of the gateway device, the first device and the second device are shown in an identifiable manner. The method according to this aspect displays the connection configuration map, in which the symbols of the respective devices are connected corresponding to the actual connections between the respective devices, the symbol of the first device is located at the position having the shorter distance in the preset first direction from the symbol of the gateway device than the symbol of the second device, and the connection interfaces of the gateway device, the first device and the second device are shown in an identifiable manner, thus readily understanding the connections between the respective devices and their connection interfaces and ensuring easy management of a plurality of devices connected by various interfaces.

In the method of the above aspect, the step (b) displaying the connection configuration map, in which the symbol of the first device is located at a position closer to the symbol of the gateway device than the symbol of the second device, on the display unit. The method of this embodiment enables the connections between the respective devices to be displayed in a sensuously understandable mode, thus improving the easiness of the management of a plurality of devices connected by various interfaces.

In the method of the above aspect, each configuration informations includes information regarding a device type, information regarding a type of a connection interface and device identification information used to identify each device. The method of this aspect enables the connection configuration map to be displayed, based on the obtained configuration information that includes information regarding a device type, information regarding a type of a connection interface and device identification information, thus ensuring easy management of a plurality of devices connected by various interfaces.

In the method of the above aspect, the step (b) displaying the connection configuration map, in which at least one of the device identification information and the information regarding the device type is displayed in correlation to each symbol, on the display unit. The method of this aspect enables the user to readily identify the device or the device type expressed by each symbol.

In the method of the above aspect, when the system includes a plurality of the first devices, the step (b) displaying the connection configuration map, in which symbols of the first devices are arrayed in a preset second direction in a preset order from the symbol of the gateway device as a starting point. The method of this aspect enables the user to readily identify how many and what devices are connected with the gateway device.

In the method of the above aspect, the step (b) displaying the connection configuration map, in which symbols of one or more second devices connected with each of the first devices are arrayed in the preset second direction, so that the symbol of the gateway device, the symbols of the first devices and the symbols of the second devices are shown in a hierarchical manner. The method of this aspect enables the user to readily differentiate between the first devices and the second devices, i.e., between the devices having a less number of devices intervening before the gateway device and the devices having a greater number of devices intervening before the gateway device.

In the method of the above aspect, the step (b) displaying the connection configuration map, in which symbols of the first devices having an identical type of the connection interfaces with the gateway device, among the symbols of the plurality of first devices, are collectively arrayed in the preset second direction. The method of this aspect enables the user to be readily informed of the number of different connection interface types between the gateway device and the first devices. Additionally, the method of this aspect enables the user to readily identify how many devices are present for each connection interface type.

In the method of the above aspect, a display area on the display unit has a longitudinal direction and a lateral direction, and the preset second direction is along the longitudinal direction. The method of this aspect enables a space to be reserved for displaying information regarding, for example, the operating condition of each device at a position adjacent to the symbol of each of the first devices in the lateral direction. Additionally, even the large-sized connection configuration map can be fully viewed by simply scrolling the display area in the longitudinal direction on the display unit.

In the method of the above aspect, the step (a) obtaining each configuration information including status-related information that is information regarding an operating condition, and the step (b) displaying the connection configuration map, in which the status-related information is displayed in connection with the symbol of the gateway device, the symbol of the first device and the symbol of the second device, on the display unit. The method of this aspect enables the user to readily understand the operating conditions of the first device and the second device.

In the method of the above aspect, the step (b) changing at least one of a display format of the symbols and a display format of connections between the symbols according to a change in operating condition shown by the status-related information. The method of this aspect enables the user to be readily and promptly informed of a change in operating condition of each device by simply checking a change in display format of the symbol of the device and a change in display format of the connection between the symbols in the connection configuration map.

In the method of the above aspect, a connection interface between the first device and the second device is either a network interface or a bus interface. The method of this aspect enables the second device to be displayed in the connection configuration map, irrespective of whether the connection interface between the first device and the second device is a network interface or a bus interface. This method effectively reduces the cost required for management, compared with the method of managing the system by using both a management device for the bus interface and a management device for the network interface.

In the method of the above aspect, the step (b) comprises: when the system includes a plurality of the first devices, displaying the connection configuration map, in which symbols of all devices, from which the configuration information has been obtained, are arrayed in the preset second direction from the symbol of the gateway device as a starting point, on the display unit, displaying the connection configuration map, in which among all the displayed symbols, a symbol of a second device, which is connected to one of the first devices, is connected with a symbol of the first device, and each connection interface between the first device and the second device is displayed in an identifiable manner, on the display unit, and displaying the connection configuration map, in which symbols of the plurality of first devices are rearranged, such that a symbol of a first device having a wireless connection interface with the gateway device is located at a closer position to the symbol of the gateway device in the preset second direction than a symbol of a first device having a wired connection interface with the gateway device, while keeping a connection relationship between the symbol of the first device and the symbol of the second device, on the display unit. According to the method of this aspect, the symbol of the first device having the wireless connection interface with the gateway device is located at the position closer to the symbol of the gateway device in the preset second direction than the symbol of the first device having the wired connection interface with the gateway device. In other words, the symbol of the first device having the wireless connection interface, which does not allow easy detection of the connection or non-connection with the gateway device, is located at the position closer to the symbol of the gateway device in the preset second direction than the symbol of the first device having the wired connection interface, which allows easy detection of the connection or non-connection with the gateway device. In general, there is a need to check the connection configuration with respect to the device, which is not easily detected to have connection or non-connection with the gateway device. The method of this aspect effectively meets this need.

According to an aspect of a computer program product, the computer program product comprises: a non-transitory computer readable storage medium; and a computer program stored in the storage medium, wherein the computer program is executed by an apparatus having a display unit to manage a system, wherein the system comprises a gateway device, a first device connected with the gateway device and a second device, wherein the second device has a greater number of devices intervening before the gateway device than the first device, wherein the computer program comprising: (a) a program code for obtaining configuration information of the gateway device, configuration information of the first device and configuration information of the second device; and (b) a program code for displaying a connection configuration map based on the configuration informations wherein the connection configuration map includes a symbol of the gateway device, a symbol of the first device and a symbol of the second device on the display unit, wherein the connection configuration map is provided, such that the symbols of the gateway device, the first device and the second device are connected corresponding to actual connections between the gateway device, the first device and the second device, such that the symbol of the first device is located at a position having a shorter distance in a preset first direction from the symbol of the gateway device than the symbol of the second device, and such that connection interfaces of the gateway device, the first device and the second device are shown in an identifiable manner. The computer program product according to this aspect displays the connection configuration map, in which the symbols of the respective devices are connected corresponding to the actual connections between the respective devices, the symbol of the first device is located at the position having the shorter distance in the preset first direction from the symbol of the gateway device than the symbol of the second device, and the connection interfaces of the gateway device, the first device and the second device are shown in an identifiable manner, thus readily understanding the connections between the respective devices and their connection interfaces and ensuring easy management of a plurality of devices connected by various interfaces.

The disclosure may be implemented by a diversity of other embodiments, for example, a device management system, a method of operating the device management system, a computer program to enable the functions of the device management system and a non-transitory computer readable storage medium, in which the computer program is recorded.

What is claimed is:

1. A method of managing a system, that includes a gateway device, a first device connected with the gateway device and a second device that is connected with the first device and has a greater number of devices intervening before the gateway device than the first device, the method comprising:
obtaining by an apparatus configuration information of the gateway device, configuration information of the first device and configuration information of the second device; and
generating and displaying on a display a connection configuration map based on the configuration information, wherein the connection configuration map includes
a symbol of the gateway device,
a symbol of the first device, and
a symbol of the second device that are displayed with display connections that correspond to actual connections between the gateway device, the first device and the second device, such that
the symbol of the first device is displayed on the display at a position having a shorter distance in a preset first direction from the symbol of the gateway device than the symbol of the second device, and
connection interfaces of the gateway device, the first device and the second device are displayed in an identifiable manner.

2. The method according to claim 1, wherein
the displaying includes displaying on the display of the apparatus the connection configuration map, in which the symbol of the first device is located at a position closer to the symbol of the gateway device than the symbol of the second device.

3. The method according to claim 1, wherein
configuration information of each device includes information regarding a device type, information regarding a type of a connection interface, and device identification information used to identify each device.

4. The method according to claim 3, wherein
the displaying includes displaying on a display of the apparatus the connection configuration map, in which at least one of the device identification information, and the information regarding the device type is displayed in correlation to each symbol.

5. The method according to claim 1, wherein
when the system includes the first device and a plurality of other first devices, the displaying includes displaying the connection configuration map, in which the symbol of the first device and symbols of the other first devices are arrayed in a preset second direction in a preset order from the symbol of the gateway device as a starting point.

6. The method according to claim 5, wherein
the displaying includes displaying the connection configuration map, in which the symbol of the second device and symbols of one or more other second devices connected with each of the first devices are arrayed in the preset second direction, so that the symbol of the gateway device, the symbol of the first device, the symbols of the other first devices, the symbol of the second device and the symbols of the one or more other second devices are displayed in a hierarchical manner.

7. The method according to claim 5, wherein
the displaying includes displaying the connection configuration map with the symbol of the first device and symbols of the other first devices that have an identical type of the connection interface with the gateway device in a collective array in the preset second direction.

8. The method according to claim 5, wherein
the displaying includes displaying the connection configuration map in a display area of the display having a longitudinal direction and a lateral direction, and
the preset second direction is along the longitudinal direction.

9. The method according to claim 3, wherein
the obtaining includes obtaining status-related information that is information regarding an operating condition, and
the displaying includes displaying on a display of the apparatus the connection configuration map, in which the status-related information is displayed in connection with the symbol of the gateway device, the symbol of the first device and the symbol of the second device.

10. The method according to claim 9, wherein
the displaying includes changing at least one of a display format for symbols and a display format for connections between symbols according to a change in operating condition shown by the status-related information.

11. The method according to claim 1, wherein
a connection interface between the first device and the second device is one of a network interface and a bus interface.

12. The method according to claim 1, wherein
the displaying includes
when the system includes a plurality of first devices, displaying on a display the connection configuration map, in which symbols of all devices, from which the configuration information has been obtained, are arrayed in the preset second direction from the symbol of the gateway device as a starting point,
displaying the connection configuration map, in which among all displayed symbols, a symbol of a second device, which is connected to one of the first devices, is connected with a symbol of the first device, and each connection interface between the first device and the second device is displayed in an identifiable manner, and
displaying the connection configuration map, in which symbols of the plurality of first devices are rearranged, such that a symbol of one device of the plurality of first devices having a wireless connection interface with the gateway device is located at a closer position to the symbol of the gateway device in the preset second direction than a symbol of another device of the plurality of first devices having a wired connection interface with the gateway device, while keeping a connection relationship between the symbol of the first device and the symbol of the second device.

13. A non-transitory computer readable storage medium having computer readable instructions stored therein that when executed by a processing circuit performs a management control method for a system, the system including
a gateway device, a first device connected with the gateway device and a second device, wherein the second device that is connected with the first device and has a greater number of devices intervening before the gateway device than the first device, wherein the management control method comprising
obtaining by the processing circuit configuration information of the gateway device, configuration information of the first device and configuration information of the second device; and
generating and displaying on a display a connection configuration map based on the configuration information, wherein the connection configuration map includes
a symbol of the gateway device,
a symbol of the first device, and
a symbol of the second device that are displayed with display connections that correspond to actual connections between the gateway device, the first device and the second device, such that
the symbol of the first device is displayed on the display at a position having a shorter distance in a preset first direction from the symbol of the gateway device than the symbol of the second device, and
connection interfaces of the gateway device, the first device and the second device are displayed in an identifiable manner.

14. The computer readable storage medium of claim 13, wherein
the displaying includes displaying the connection configuration map, in which the symbol of the first device is located at a position closer to the symbol of the gateway device than the symbol of the second device.

15. The computer readable storage medium of claim 13, wherein
configuration information for each device includes information regarding a device type, information regarding a type of a connection interface and device identification information used to identify each device.

16. The computer readable storage medium of claim 15, wherein
the displaying includes displaying the connection configuration map, in which at least one of the device identification information and the information regarding the device type is displayed in correlation to each symbol.

17. The computer readable storage medium of claim 13, wherein
when the system includes the first device and a plurality of other first devices, the displaying includes displaying the connection configuration map, in which the symbol of the first device and symbols of the other first devices are arrayed in a preset second direction in a preset order from the symbol of the gateway device as a starting point.

18. The computer readable storage medium of claim 17, wherein
the displaying includes displaying the connection configuration map, in which symbols of one or more other second devices connected with each of the first devices are arrayed in the preset second direction, so that the symbol of the gateway device, the symbol of the first device, the symbols of the other first devices, and the symbols of the second devices are displayed in a hierarchical manner.

19. The computer readable storage medium of claim 17, wherein
the displaying includes displaying the connection configuration map with the symbol of the first device and symbols of the other first devices that have an identical type of the connection interface with the gateway device in a collective array in the present second direction.

20. The computer readable storage medium of claim 17, wherein
the displaying includes displaying the connection configuration map in a display area of the display having a longitudinal direction and a lateral direction, and
the preset second direction is along the longitudinal direction.
